(19) United States
(12) Patent Application Publication
(10) Pub. No.: US 2011/0050760 A1
(43) Pub. Date: Mar. 3, 2011

(54) IMAGE DISPLAY APPARATUS AND CONTROL APPARATUS AND INTEGRATED CIRCUIT THEREOF

(75) Inventors: Takeshi ITO, Osaka (JP); Haruo YAMASHITA, Osaka (JP)

(73) Assignee: PANASONIC CORPORATION, Osaka (JP)

(21) Appl. No.: 12/829,930

(22) Filed: Jul. 2, 2010

(30) Foreign Application Priority Data
Jul. 2, 2009 (JP) 2009-157590

(51) Int. Cl. G09G 5/10

(52) U.S. Cl. 345/694

(57) ABSTRACT

An image display apparatus can display high-quality images. A backlight section (20) has a plurality of light sources disposed such that a plurality of light emitting areas are formed. A liquid crystal panel (10) displays images by modulating light from the backlight section (20) according to the transmittance of light. A backlight controlling section (41) generates a first brightness signal which indicates a brightness signal, per light emitting area, and controls the light emission brightness value of the backlight section (20) per light emitting area using the first brightness signal the controlling section (40) that controls the liquid crystal display apparatus (1) calculates the transmittance based on the input image signal and a brightness value of light that is determined from the first brightness signal where the light arrives at pixels of the display section, generates a second brightness signal which indicates a brightness value, per sub-area acquired by segmenting a light emitting area, based on the first brightness signal and performs processing corresponding to a brightness distribution of a light emitting area, with respect to the second brightness signal.

### CROSS REFERENCE TO RELATED APPLICATIONS

This application is entitled to or claims the benefit of Japanese Patent Application No. 2009-157590, filed on Jul. 2, 2009, the disclosure of which including the specification, drawings and abstract, is incorporated herein by reference in its entirety.

### TECHNICAL FIELD

The technical field relates to an image display apparatus, and its controlling apparatus and integrated circuit.

### BACKGROUND ART

Recently, a liquid crystal display apparatus that can display images of still images and motion images are rapidly spreading thanks to cost reduced by advancement in a manufacturing technique, reduction in the thickness and the weight of the liquid crystal display apparatus, and advancement in a technique for providing high-quality images in display functions. A liquid crystal display apparatus is widely used in, for example, a personal computer (PC) monitor and a digital TV that receives and displays digital broadcasting waves.

As the above liquid crystal display apparatus, there are mainly a reflection-type liquid crystal display apparatus and a transmission-type liquid crystal display apparatus. Among these two, the transmission type liquid crystal display apparatus is generally used widely. This transmission type liquid crystal display apparatus has a planar light source that is referred to as a “backlight” formed with, for example, a cold cathode fluorescent tube, and, in the liquid crystal panel, spatially modulates the light radiated from the planar light source and displays desired images.

In case where, for example, desired images are dark images, the above conventional liquid crystal display apparatus express dark images by adjusting the transmittance of light in the liquid crystal panel, and does not adjust the brightness in the backlight. Therefore, even in case of these dark images, the backlight emits light at the maximum brightness, and therefore there is a problem of high power consumption. Further, the transmittance of light in the liquid crystal panel does not become completely zero, and therefore a phenomenon referred to as “impure black” that light from the backlight leaks and is displayed white in images of dark scenes occur.

By contrast with this, a technique of changing the brightness of the backlight locally by segmenting the screen using light sources such as LEDs is being proposed. Patent Literature 1 discloses a technique of handling in an area the amount of light coming from light sources of other areas. Further, Patent Literature 2 discloses a configuration calculating a brightness distribution between backlight areas using an approximate function. Furthermore, Patent Literature 3 discloses correcting the gradation according to brightness levels of light sources of other areas.

### CITATION LIST

### Patent Literature

### PTL 1: Japanese Patent Application Laid-Open No. 2007-034251

### PTL 2: Japanese Patent Application Laid-Open No. 2005-258403

### PTL 3: Japanese Patent Application Laid-Open No. 2002-99250

### Summary

### Technical Problem

By the way, in case where the technique of changing the brightness of the backlight locally by segmenting the screen using light sources such as light emitting diodes (LEDs) is employed, performing control to maintain the brightness for displaying an image at the same brightness as an image signal is not possible unless the light emission brightness value of every pixel is learned. Further, the light emission brightness value of every pixel cannot be learned without taking into account the amount of light coming from a light source of another area per pixel.

The object is to provide an image display apparatus that can display high-quality images, and its controlling apparatus and integrated circuit.

### Solution to Problem

In order to achieve the above object, the image display apparatus includes: a light source section that has a plurality of light sources disposed such that a plurality of light emitting areas are formed; a display section that displays an image by modulating light from the light source section according to a modulation factor corresponding to an input image signal; a light controlling section that generates a first brightness signal which indicates a brightness value, per light emitting area, and that controls a light emission brightness value of the light source section per light emitting area using the generated first brightness signal; and a controlling section that controls the image display apparatus, and the controlling section; calculates the modulation factor based on the input image signal and a brightness value of light which is determined from the generated first brightness signal, the light arriving at pixels of the display section; generates a second brightness signal which indicates a brightness value, per sub-area acquired by segmenting a light emitting area, based on the generated first brightness signal; and performs processing corresponding to a brightness distribution of a light emitting area, with respect to the generated second brightness signal.

Further, in order to achieve the above object, the controlling apparatus that controls an image display apparatus that displays an image, by modulating light from a light source section comprising a plurality of light sources disposed such that a plurality of light emitting areas are formed, according to a modulation factor corresponding to an input image signal, includes: a light source controlling section that generates a first brightness signal which indicates a first brightness signal, per light emitting area, and that controls a light emitting brightness value of the light source section per light emitting area using the generated first brightness signal; and a controlling section that calculates a modulation factor based on the input image signal and a brightness value of light that is determined from the generated first brightness signal, the light arriving at a pixel of the display section, and the controlling section generates a second brightness signal which indicates a brightness value, per sub-area acquired by segmenting a light emitting area, based on the generated first brightness signal, and performs processing corresponding to a brightness distribution in a light emitting area, with respect to the generated second brightness signal.

Furthermore, in order to achieve the above object, the integrated circuit controls an image display apparatus, the image display apparatus has: a light source section that has a plurality of light sources disposed such that a plurality of light emitting areas are formed; a display section that displays an image by modulating light from the light source section according to a modulation factor corresponding to an input image signal, the integrated circuit has: a light source controlling section that generates a first brightness signal which indicates a brightness value, per light emitting area, and that controls a light emission brightness value of the light source section per light emitting area, using the generated first brightness signal; a controlling section that controls the image display apparatus, and the controlling section; calculates the modulation factor based on the input image signal and a brightness value of light that is determined from the generated first brightness signal, the light arriving at a pixel of the display section; generates a second brightness signal which indicates a brightness value, per sub-area acquired by segmenting a light emitting area, based on the generated first brightness signal; and performs processing corresponding to a brightness distribution of a light emitting area, with respect to the generated second brightness signal.

### ADVANTAGEOUS EFFECTS

This apparatus can display high-quality images.

### BRIEF DESCRIPTION OF DRAWINGS

FIG. 1 is a schematic diagram showing a liquid crystal display apparatus according to Embodiment 1 of the present invention;

FIG. 2 shows a specific configuration of a backlight section according to Embodiment 1 of the present invention;

FIG. 3 is a schematic diagram showing a specific configuration of a controlling section according to Embodiment 1 of the present invention;

FIG. 4 is a schematic diagram showing a specific configuration of a brightness estimating section according to Embodiment 1 of the present invention;

FIG. 5 illustrates a basic operation of a subblock segmenting section according to Embodiment 1 of the present invention;

FIG. 6 illustrates interpolation processing in an interpolating section according to Embodiment 1 of the present invention;

FIG. 7 shows an example of an image signal received as input in a liquid crystal display apparatus according to Embodiment 1 of the present invention;

FIG. 8 shows the transmittance set in an image signal according to Embodiment 1 of the present invention;

FIG. 9 shows brightness signals generated based on the transmittance shown in FIG. 8;

FIG. 10 shows segmentation of light emitting areas in a subblock segmenting section and numerical examples of brightness signal calculation according to Embodiment 1 of the present invention;

FIG. 11 shows numerical examples of a filter used in a brightness distribution filter section according to Embodiment 1 of the present invention;

FIG. 12 illustrates filter processing performed per subblock according to Embodiment 1 of the present invention;

FIG. 13 shows an estimated light emission brightness value of each pixel calculated based on a brightness signal of each subblock, according to Embodiment 1 of the present invention;

FIG. 14 is a schematic diagram showing a configuration of a brightness distribution filter section according to Embodiment 2 of the present invention;

FIG. 15 illustrates a filter having horizontal light emission characteristics, according to Embodiment 2 of the present invention;

FIG. 16 illustrates filter processing performed per subblock, according to Embodiment 2 of the present invention;

FIG. 17 shows an output result from a horizontal direction brightness distribution filter section, according to Embodiment 2 of the present invention;

FIG. 18 illustrates a filter having vertical light emission characteristics, according to Embodiment 2 of the present invention;

FIG. 19 illustrates filter processing performed per subblock, according to Embodiment 2 of the present invention;

FIG. 20 shows a brightness signal of each subblock after filter processing, according to Embodiment 2 of the present invention;

FIG. 21 is a schematic diagram showing a brightness estimating section according to Embodiment 3 of the present invention;

FIG. 22 shows a filter used in a first brightness distribution filter section according to Embodiment 3 of the present invention;

FIG. 23 illustrates filter processing performed per light emitting area, according to Embodiment 3 of the present invention;

FIG. 24 shows a brightness signal of each light emitting area outputted from a first brightness distribution filter section according to Embodiment 3 of the present invention;

FIG. 25 shows segmentation of light emitting areas in a subblock segmenting section and numerical examples of brightness signal calculation, according to Embodiment 3 of the present invention;

FIG. 26 shows numerical examples of a filter used in a second brightness distribution filter section according to Embodiment 3 of the present invention;

FIG. 27 illustrates filter processing performed per subblock, according to Embodiment 3 of the present invention;

FIG. 28 shows a brightness signal of each subblock outputted from a second brightness distribution filter section according to Embodiment 3 of the present invention;

FIG. 29 shows a configuration in which a reflecting plate is provided in a backlight section, according to another embodiment of the present invention;

FIG. 30 shows a configuration of a controlling section that can control red, green and blue independently in a backlight section, according to another embodiment of the present invention;

FIG. 31 shows an example of irregular pitch alignment of light sources according to another embodiment of the present invention; and

FIG. 32 shows an example of delta alignment of light sources according to another embodiment of the present invention.

### DESCRIPTION OF EMBODIMENTS

### Content

1. Embodiment 1 of the present invention is directed to “performing filter processing by dividing a brightness signal of each light emitting area into subblocks”
1-1 Configuration of liquid crystal display apparatus
1-1-1. Liquid crystal panel
1-1-2. Backlight section
1-1-3. Backlight driver
1-1-4. Controlling section
1-1-4-1. Backlight controlling section
1-1-4-2. Brightness estimating section
1-1-4-2-1. Block memory controlling section
1-1-4-2-2. Block memory
1-1-4-2-3. Subblock segmenting section
1-1-4-2-3-1. Method of segmenting light emitting areas
1-1-4-2-3-2. Method of generating brightness signals corresponding to subblocks
1-1-4-2-4. Subblock memory controlling section
1-1-4-2-5. Subblock memory
1-1-4-2-6. Brightness distribution filter section
1-1-4-2-7. Interpolating section
1-1-4-3. Signal correcting section
1-1-4-4. Image correcting section
1-2. Operation of liquid crystal display apparatus
1-2-1. Light emitting operation of backlight section
1-2-2. Division of brightness signal, and filter processing operation

### 1-3. Conclusion

2. Embodiment 2 (modified example of brightness distribution filter section)
2-1. Brightness distribution filter section
2-1-1. Horizontal direction brightness distribution filter section
2-1-2. Vertical direction brightness distribution filter section
2-2. Operation of brightness distribution filter section

### 2-3. Conclusion

3. Embodiment 3 (modified example of brightness distribution filter section)
3-1. Brightness estimating section
3-1-1. First brightness distribution filter section
3-1-2. Second brightness distribution filter section
3-2. Division of brightness signal, and filter processing operation

### 3-3. Conclusion

Hereinafter, the best embodiments for carrying out the present invention will be explained with reference to the accompanying drawings.

### Embodiment 1

Hereinafter, Embodiment 1 of the present invention will be explained with reference to the accompanying drawings.

<1-1. Configuration of Liquid Crystal Display Apparatus>

First, a configuration of a liquid crystal display apparatus will be explained.

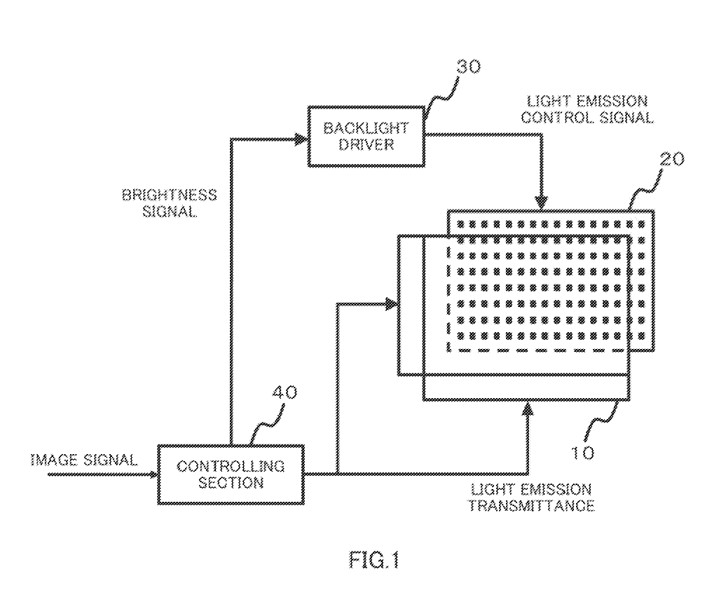

FIG. 1 is a schematic diagram showing a liquid crystal display apparatus according to Embodiment 1 of the present invention.

Liquid crystal display apparatus 1 has liquid crystal panel 10, backlight section 20, backlight driver 30 and controlling section 40. Hereinafter, the configuration of each section will be explained in detail.

<1-1-1. Liquid Crystal Panel>

Liquid crystal panel 10 as a displaying section displays an image by modulating illumination light radiated on the back surface of liquid crystal panel 10 by backlight section 20, according to a control signal received as input from controlling section 40.

Further, liquid crystal panel 10 employs a configuration in which a liquid crystal layer is sandwiched between glass substrates, and a signal voltage is applied to the liquid crystal layer meeting each pixel by the gate driver (not shown) and source driver (not shown), and the transmittance is controlled per pixel. The gate driver and source driver provided in liquid crystal panel 10 employ a configuration receiving a control signal from controlling section 40.

Further, liquid crystal panel 10 uses the IPS (In-Plane Switching) scheme. Liquid crystal molecules make a simple motion of rotating in parallel with the glass substrate, so that the IPS scheme provides a wide view angle, and has characteristics that change in color hue depending on viewing directions is little and change in color hue in full tonal gradation is little.

Note that liquid crystal panel 10 may be any device as long as it performs optical modulation, and, for example, the VA (Vertical Alignment) scheme may be employed as another optical modulation scheme.

That is, liquid crystal panel 10 is a type of a non-self-luminous display device, and it is equally possible to substitute a non-self-luminous display device of another type for a display section of the present invention. Hence, the image display apparatus according to the present invention is not limited to the liquid crystal display apparatus. Further, the transmittance is an optical modulation factor which is used in case where the display device is a liquid crystal panel and which is determined according to an image signal of each pixel, and therefore other optical modulation factors are used in case where the display device is not a liquid crystal panel.

<1-1-2. Backlight Section>

Backlight section 20 as a light source section is a device that radiates illumination light for displaying an image, on the back surface of liquid crystal panel 10.

Backlight section 20 has a plurality of light sources 21. Based on a light emission control signal outputted from backlight driver 30, backlight section 20 controls as a base unit a light emitting area that is a unit of at least one or more light sources 21. Each light emitting area is provided to face each image display area of liquid crystal panel 10 and mainly illuminates the facing image display area. Here, the word “mainly” suggests that each light emitting area may radiate part of its illuminating light on other image display areas that the light emitting area does not face.

Note that, to make light radiated from light emitting areas uniform, a diffusing sheet may be provided between liquid crystal panel 10 and backlight section 20.

Here, light source 21 uses an LED that emits white light. Note that light source 21 is not limited to a light source that directly emits white light. For example, light source 21 may emit white light by blending, for example, red, green and blue lights. Further, other types of light sources (for example, semiconductor laser light sources or organic EL (Electroluminescence) light sources) may be used instead of LEDs.

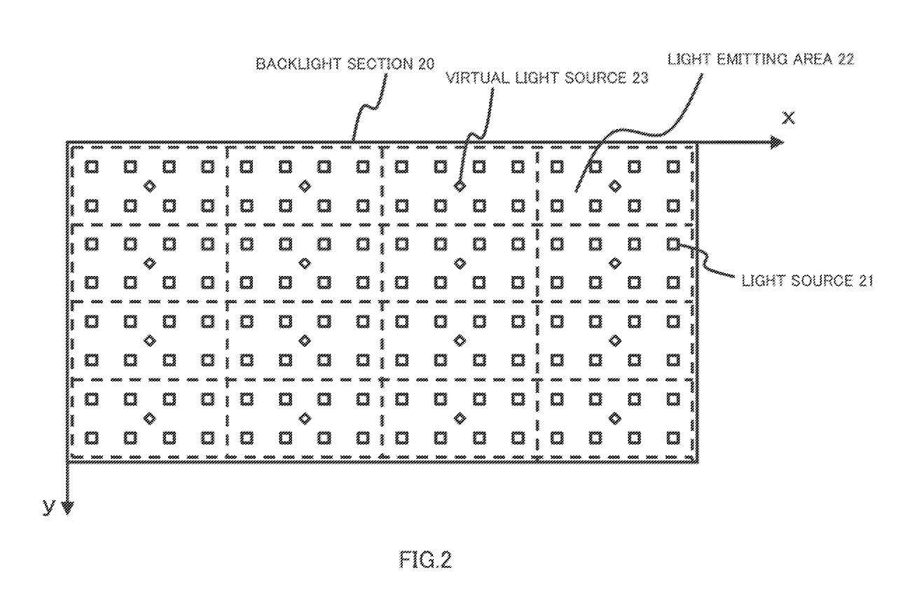

FIG. 2 shows a specific configuration of backlight section 20.

Backlight section 20 is a direct type backlight apparatus having characteristics that a plurality of light sources 21 are uniformly aligned on the surface facing the back surface of liquid crystal panel 10. Further, backlight section 20 has light emitting areas 22 in which eight light sources 21 form one unit. These light sources 21 employ a configuration provided with a diffusing plate such that light emitting areas 22 emit light uniformly. Further, light emitting area 22 has virtual light source 23 that is configured to virtually use eight light sources 21 as one light source. Virtual light source 23 is set in the reference position inside the light emitting area. Further, as shown in FIG. 2, backlight section 20 has sixteen light emitting areas.

Note that the x axis direction and the y axis direction shown in FIG. 2 correspond to the horizontal direction and the vertical direction, respectively, in the display screen of liquid crystal panel 10, and, in the following explanation, the x axis direction and the y axis direction will be referred to as “the horizontal direction” and “the vertical direction,” respectively.

Controlling section 40 controls light emitting area 22 by controlling this virtual light source 23. Although the position to arrange virtual light source 23, that is, the reference position inside light emitting area 22, is the center portion of light emitting area 22 with the example shown in FIG. 2, in case where eight light sources 21 are controlled simultaneously, any arrangement is possible as long as these light sources 21 can emit light uniformly to light emitting area 22. Depending on the degree of diffusion of light of each light source 21 or how each light source 21 is disposed, the reference position inside light emitting area 22 may assume the position off the center of light emitting area 22.

<1-1-3. Backlight Driver>

Backlight driver 30 generates a light emission control signal based on a brightness signal which is received as input from controlling section 40 and for which the light emission ratio is set per light emitting area. Further, backlight driver 30 outputs the generated light emission control signal to backlight section 20. The light emission control signal is a signal for controlling drive of individual light sources 21. Note that backlight driver 30 can be realized by, for example, an electrical circuit.

<1-1-4. Controlling Section>

Controlling section 40 generates a light emission transmittance that defines the transmittance of the liquid crystal layer meeting each pixel of liquid crystal panel 10, based on an image signal received as input (simply “input image signal”). Further, controlling section 40 generates a brightness signal (i.e. first brightness signal) that defines the light emission ratio for each of a plurality of light emitting areas provided in backlight section 20. Controlling section 40 is realized by combining a computation processing apparatus (for example, CPU (Central Processing Unit)) and a storing apparatus, and forms the controlling apparatus of the present invention.

With the present embodiment, backlight section 20 is segmented into sixteen as shown in FIG. 2, and therefore controlling section 40 generates sixteen brightness signals per frame of an input signal.

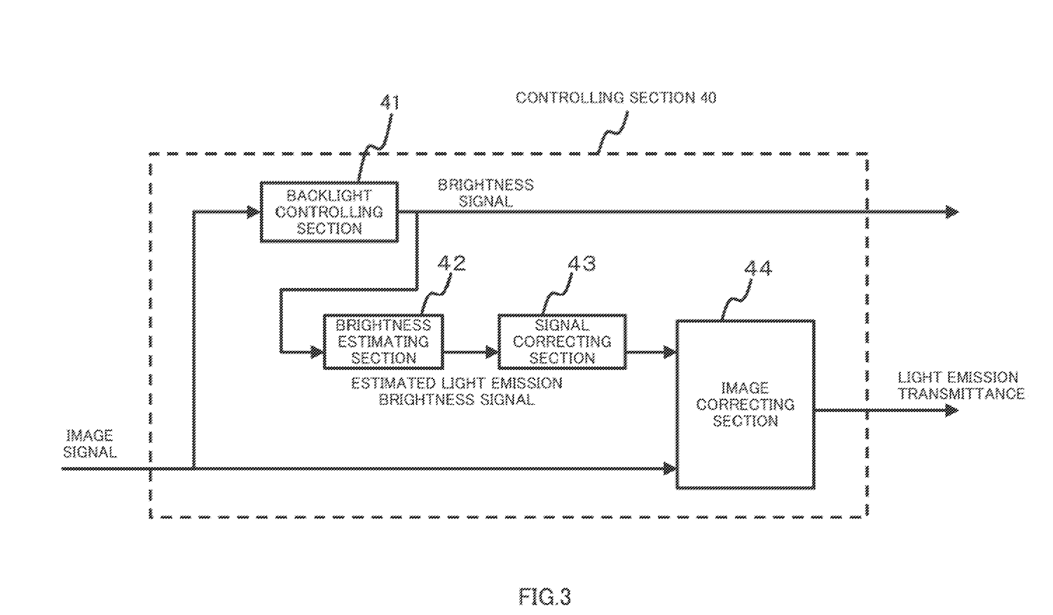

FIG. 3 is a schematic diagram showing a specific configuration of controlling section 40.

Specifically, controlling section 40 has backlight controlling section 41, brightness estimating section 42, signal correcting section 43 and image correcting section 44.

<1-1-4-1. Backlight Controlling Section>

Backlight controlling section 41 as a light source controlling section generates a brightness signal (i.e. first brightness signal) based on an input image signal. Backlight controlling section 41 outputs the generated brightness signal to backlight driver 30 and brightness estimating section 42.

Note that the brightness signal generated in backlight controlling section 41 is a signal that determines the light emission ratio of each virtual light source 23, and shows the rate of the light emission brightness based on the maximum brightness value of each virtual light source 23. Note that, for ease of explanation, the rate in case where the non-light emission brightness is set to 0, the maximum brightness is set to 255 and this maximum brightness of 255 is set to 1, is indicated by a brightness signal. For example, if the light emission brightness is 128, the brightness signal is 0.5.

<1-1-4-2. Brightness Estimating Section>

Brightness estimating section 42 generates an estimated light emission brightness signal indicating an estimation value (hereinafter “estimated light emission brightness value”) of the display brightness in each pixel provided in liquid crystal panel 10, based on the brightness signal received as input from backlight controlling section 41. Brightness estimating section 42 outputs an estimated light emission brightness signal to signal correcting section 43.

Hereinafter, the specific configuration of brightness estimating section 42 will be explained with reference to the accompanying drawings.

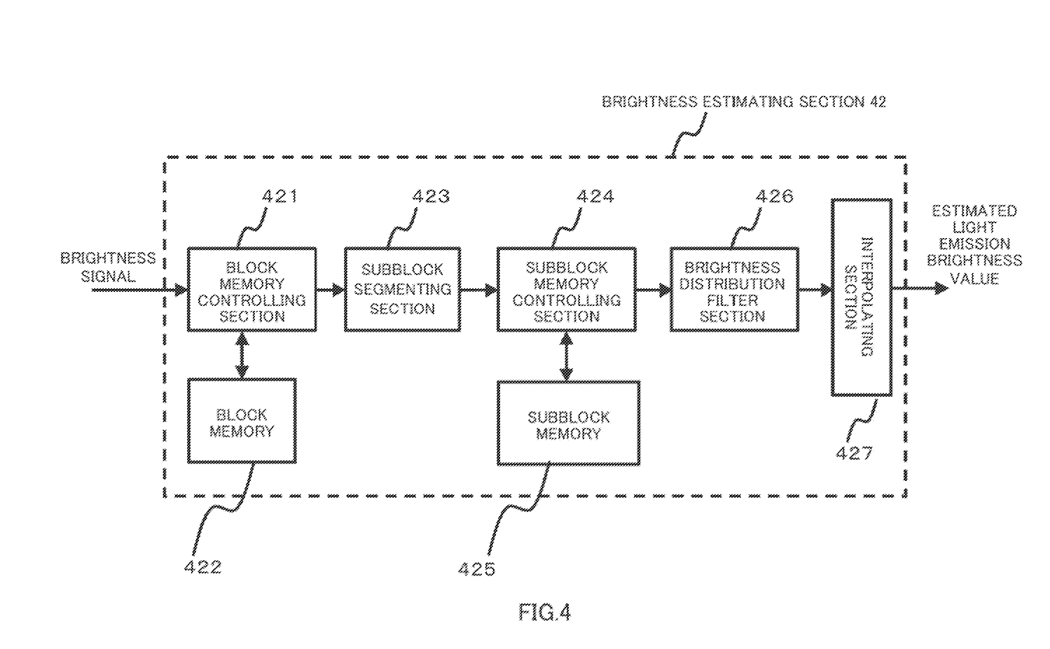

FIG. 4 is a schematic diagram showing a specific configuration of brightness estimating section 42.

Brightness estimating section 42 has block memory controlling section 421, block memory 422, subblock segmenting section 423, subblock memory controlling section 424, subblock memory 425, brightness distribution filter section 426 and interpolating section 427.

<1-1-4-2-1. Block Memory Controlling Section>

Block memory controlling section 421 reads and writes information to be accumulated in block memory 422, and, in addition, outputs information read from block memory 422, to subblock segmenting section 423.

To be more specific, when a brightness signal is received as input from backlight controlling section 41, block memory controlling section 421 accumulates the input brightness signal in block memory 422. Note that, with the present embodiment, block memory controlling section 421 accumulates brightness signals in all light emitting areas of backlight section 20.

Further, block memory controlling section 421 outputs brightness signals that are accumulated in block memory 422 and that match virtual light sources 23, to subblock segmenting section 423.

<1-1-4-2-2. Block Memory>

Block memory 422 accumulates a brightness signal that is received as input from block memory controlling section 421 and that is set per light emitting area.

<1-1-4-2-3. Subblock Segmenting Section>

Subblock segmenting section 423 segments light emitting area 22 into subblocks, and generates a brightness signal (i.e. second brightness signal) per subblock. That is, subblock segmenting section 423 segments light emitting area 22 into a plurality of subblocks (i.e. sub-areas) that are smaller than this light emitting area.

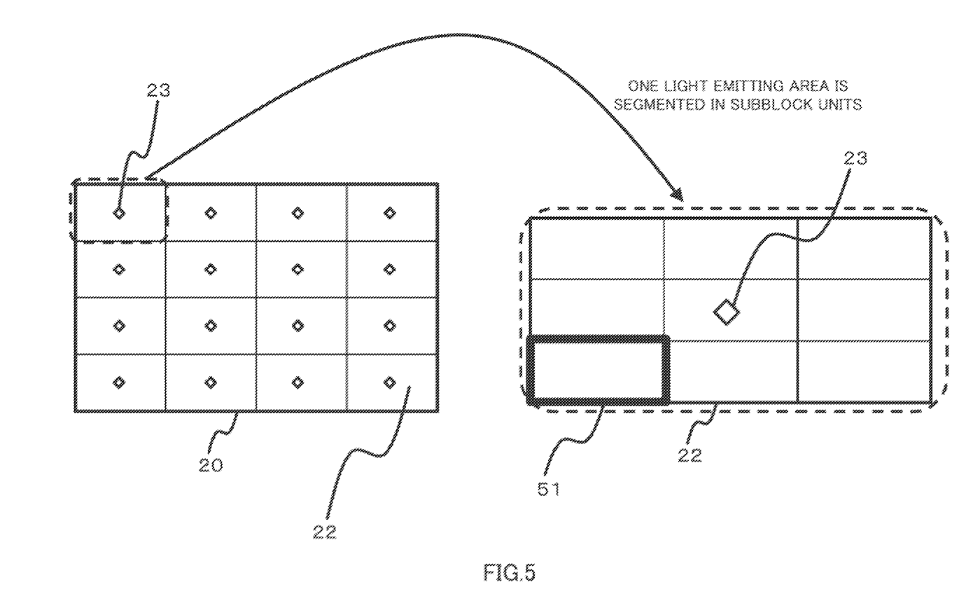

FIG. 5 illustrates a basic operation of subblock segmenting section 423. FIG. 5 shows the operation of segmenting one light emitting area 22 into nine subblocks 51.

Note that, although one light emitting area 22 is segmented into nine subblocks 51 with the present embodiment, the number of segments (that is, the number of subblocks obtained by segmenting one light emitting area) may be increased or decreased taking into account the accuracy of computation, the amount of processing and so on.

Subblock segmenting section 423 segments one light emitting area into nine subblocks 51 as shown in FIG. 5, and calculates a brightness signal per subblock 51. Therefore, in case where backlight section 20 is segmented into sixteen and sixteen brightness signals are generated by backlight controlling section 41, subblock segmenting section 423 generates 144 brightness signals for backlight section 20 on the whole.

Subblock segmenting section 423 outputs segmentation information (for example, the number of segments of light emitting areas and the segmenting method thereof) related to segmentation of light emitting areas, and the brightness signal calculated per subblock, to subblock memory controlling section 424.

Hereinafter, the method of segmenting light emitting areas by subblock segmenting section 423 and the method of generating brightness signals corresponding to subblocks will be explained.

<1-1-4-2-3-1. Method of Segmenting Light Emitting Area>

When one light emitting area is segmented into subblocks, subblock segmenting section 423 segments the light emitting area such that subblocks 51 become virtually rectangular. Here, subblocks 51 are made virtually rectangular because a shape that is not strictly a square shape of 1:1.3 is possible. For example, in case where the aspect ratio of light emitting areas 22 is 9:16, subblock segmenting section 423 is configured to segment light emitting areas 122 into 144 virtually rectangular subblocks.

By segmenting the light emitting areas into virtually rectangular subblocks, it is possible to handle light emitting areas in which light sources 21 are disposed to spread horizontally (for example, light sources 21 of 4 columns×2 rows) like light emitting areas in which the same number of light sources 21 are disposed in the horizontal direction and the vertical direction. Consequently, even in case where the degree of diffusion of light of each light source 21, the method of disposing each light source 21 and the number of light sources 21 included in light emitting area 22 change, it is possible to set brightness signals in light emitting areas in a fine manner.

Note that subblock segmenting section 423 may segment light emitting areas 22 in proportion to the number of light sources 21 included in light emitting areas 22. To be more specific, when it is decided that eight light sources 21 are included in light emitting area 22, subblock segmenting section 423 segments this light emitting area into eight subblocks 51. In this case, the light emitting area can be used in the same way control is performed in light sources 21 units, so that it is possible to set brightness signals in light emitting areas in a fine manner.

<1-1-4-2-3-2. Method of Generating Brightness Signals Corresponding to Subblocks>

When a brightness signal is calculated per subblock, subblock segmenting section 423 may set a brightness signal of a light emitting area with respect to all subblocks inside one light emitting area. For example, in case where the brightness signal of the light emitting area is 0.5, all brightness signals of subblocks inside this light emitting area are set to 0.5.

Note that subblock segmenting section 423 may employ a configuration of, when calculating a brightness signal per subblock, performing filter processing of these subblocks. The filter coefficient for performing filter processing is a value set according to the degree of diffusion of light of each light source 21, the method of disposing each light source 21 and the number of light sources 21 provided in light emitting area 21. Further, in case where a diffusing plate is provided, the filter coefficient may be set based on the light diffusion characteristics of this diffusing plate.

For example, in case where light sources 21 inside light emitting area 21 are disposed to spread horizontally (for example, light sources 21 of 4 columns×2 rows), if virtual light source 23 is placed in the center of the light emitting area, the filter coefficient is set such that brightness signals change in a virtually oval pattern around virtual light source 23.

With the above configuration, it is possible to express fine light emission characteristics inside light emitting area 22 and, consequently, calculate brightness signals adequately.

<1-1-4-2-4. Subblock Memory Controlling Section>

Subblock memory controlling section 424 reads and writes information to be accumulated in subblock memory 425, and outputs information read from subblock memory 425, to brightness distribution filter section 426.

To be more specific, subblock memory controlling section 424 performs control such that, when segmentation information and a brightness signal set per subblock are received as input from subblock segmenting section 423, the segmentation information and the brightness signal are accumulated in subblock memory 425. Note that, with the present embodiment, subblock memory controlling section 424 performs control such that brightness signals in all light emitting areas of backlight section 20 are accumulated.

Further, subblock memory controlling section 424 outputs the segmentation information and brightness signal set per subblock that are accumulated in subblock memory 425, to brightness distribution, filter section 426.

<1-1-4-2-5. Subblock Memory>

Subblock memory 425 accumulates segmentation information and a brightness signal set per subblock that are received as input from subblock memory controlling section 424.

<1-1-4-2-6. Brightness Distribution Filter Section>

Brightness distribution filter section 426 performs filter processing of segmentation information and a brightness signal of each subblock received as input from subblock memory controlling section 424. Further, brightness distribution filter section 426 outputs the brightness signal of each subblock acquired from this filter processing, to interpolating section 427.

The filter that performs this filter processing is set as a two-dimensional filter, and has brightness distribution characteristics of virtual light source 23. That is, by performing filter processing of the brightness signal calculated per subblock using this filter, it is possible to convert the brightness signal into a brightness signal taking into account the influence of virtual light source 23 of interest upon the brightness signal and, in addition, the influence of the virtual light sources disposed around virtual light source 23 of interest. Here, the influence from virtual light sources disposed around the virtual light source of interest refers to, for example, light leaking from neighboring light emitting areas, and, in case where light sources 21 are LEDs, refers to the influence of light diffusion characteristics of LED lenses.

Note that the filter size may be set according to the number of segments, and set to a size greater than the number of segments. For example, in case where backlight section 20 is segmented into subblocks of eight rows and eight columns, the filter size is set to the size of fifteen rows and fifteen columns.

Further, the filter used in brightness distribution filter section 426 may be held in this brightness distribution filter section 426, or may be held in an external memory so as to be read when filter processing is performed.

<1-1-4-2-7. Interpolating Section>

Interpolating section 427 calculates an estimated light emission brightness value per pixel provided in liquid crystal panel 10, based on the brightness signal that is received as input from brightness distribution filter section 426 and that is calculated per subblock. Here, the estimated light emission brightness value refers to “light emission brightness value” in pixels provided in liquid crystal panel 10 that is estimated from a brightness signal of each light emitting area and that is calculated based on an image signal.

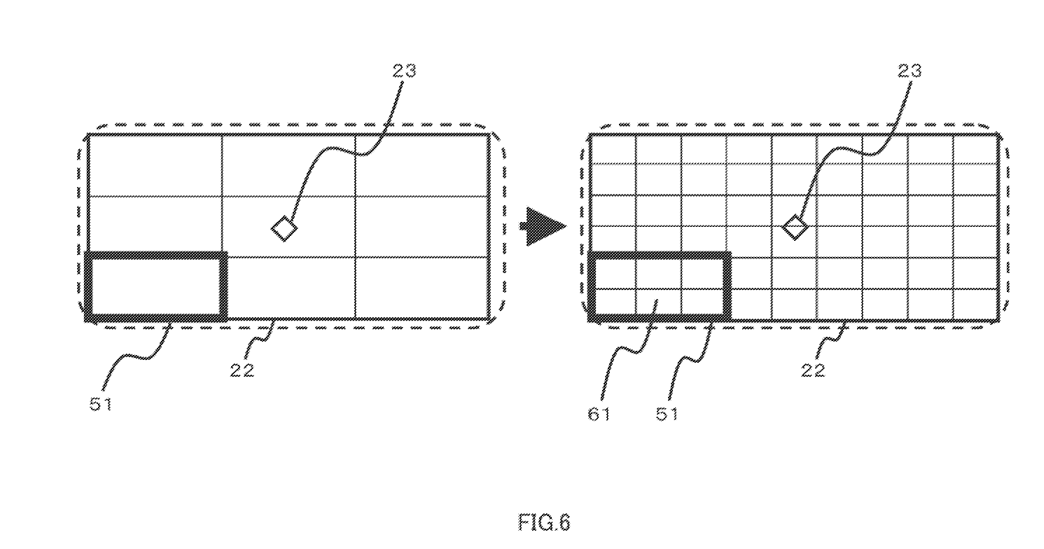

FIG. 6 illustrates interpolation processing in interpolating section 427. FIG. 6 shows that, in light emitting area 22 that is segmented into nine subblocks 51, these subblocks 51 are segmented per pixel 61. Note that, in FIG. 6, although six pixels 61 are provided in subblock 51, the number of pixels provided in subblock 51 may be any value.

To be more specific, in case where a brightness signal of 0.5 is set to subblock 51, interpolating section 427 sets the estimated light emission brightness values of all pixels included in this subblock 51, to 0.5.

Note that the operation is not limited to the above, interpolation processing that is generally used to calculate an estimated light emission brightness value per pixel 61 may be used. Further, after the estimated light emission brightness value is calculated per pixel as described above, filter processing such as lowpass filtering may be performed. By performing filter processing using a lowpass filter after subblocks are segmented per pixel, the characteristics of the brightness to be seen become smooth, so that it is possible to display natural images through a liquid crystal panel. Further, the filter used in the above filter processing is not limited to a lowpass filter, and a filter that is set according to, for example, light emission characteristics in backlight section 20 may be used.

<1-1-4-3. Signal Correcting Section>

Signal correcting section 43 detects characteristics of an input image signal, and converts the characteristics of the estimated light emission brightness value estimated in brightness estimating section 42 according to the characteristics of the image signal. For example, in case where an input image signal is subjected to gamma conversion, gamma conversion is applied to an estimated light emission brightness value. As a specific conversion method, a conversion table may be used.

<1-1-4-4. Image Correcting Section>

Based on an estimated light emission brightness value of a pixel of interest in liquid crystal panel 10 outputted from signal correcting section 43 and the transmittance of the pixel of interest that an input image signal has, image correcting section 44 corrects this transmittance and outputs the corrected transmittance.

In case where brightness is controlled per light emitting area in backlight section 20, even if signals received as input in liquid crystal panel 10 and backlight section 20 are generated based on the same image signal, a difference is produced in brightness between display images due to the difference in brightness between light emitting areas illuminating the display area for this image. Therefore, there are cases where display images look unnatural. This problem occurs because an input image signal is generated on the precondition of uniform light emission from all light sources in backlight section 20.

Image correcting section 44 corrects the transmittance in predetermined pixels defined by an image signal such that a display brightness value of an image displayed on liquid crystal panel 10 is changed in conjunction with the estimated light emission brightness value in the predetermined pixels that is generated from the brightness signal of the light emitting area. This correction of transmittance reduces the above difference in brightness in a display image, thereby preventing unnatural images, so that it is possible to display high-quality images.

Here, transmittance T in a pixel of interest relates to display brightness value Y in the pixel of interest that is segmented by light emission brightness value L as shown in, for example, equation 1.

$$\begin{matrix}( Equation 1 ) & \\ T = \frac{Y}{L} & [ 1 ]\end{matrix}$$

In order to make the display brightness values in pixels constant in a situation in which brightness signals of light emitting areas are changing, it is necessary to correct the transmittance in pixels in liquid crystal panel 10. Then, image correcting section 44 corrects the transmittance based on, for example, equation 1 using estimated light emission brightness value tilde L outputted from signal correcting section 43 as light emission brightness value L.

Further, the transmittance is corrected for each of red, green and blue signals included in an image signal.

<1-2. Operation of Liquid Crystal Display Apparatus>

Next, a specific example of a display operation in a liquid crystal display apparatus based on the above configuration will be explained with reference to the accompanying drawings. Assume that, with the present embodiment, light radiated from virtual light sources 23 is not reflected in the surrounding of backlight section 20.

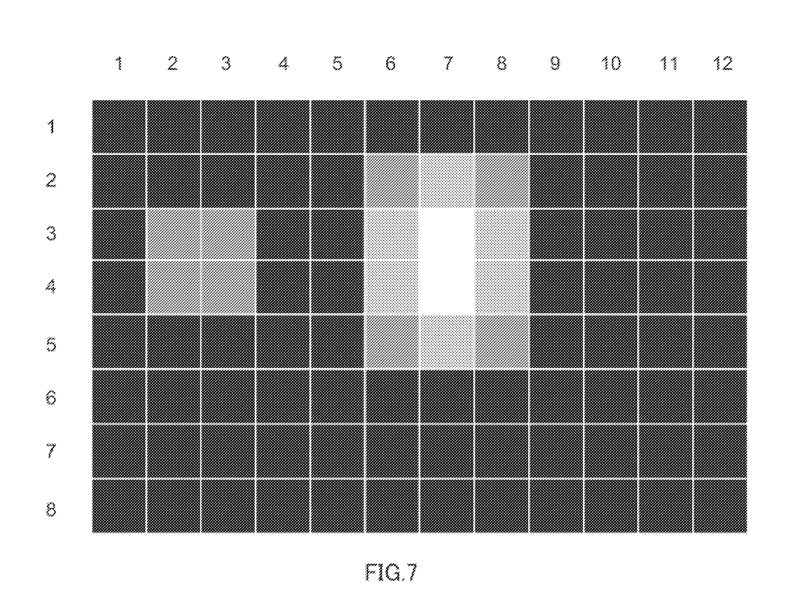

FIG. 7 shows an example of an image signal received as input in the liquid crystal display apparatus. Two big and small rectangular patterns are arranged on a black background. Note that the white grid lines in FIG. 7 indicate the frames of pixels in liquid crystal panel 10, and are not included in the actual image.

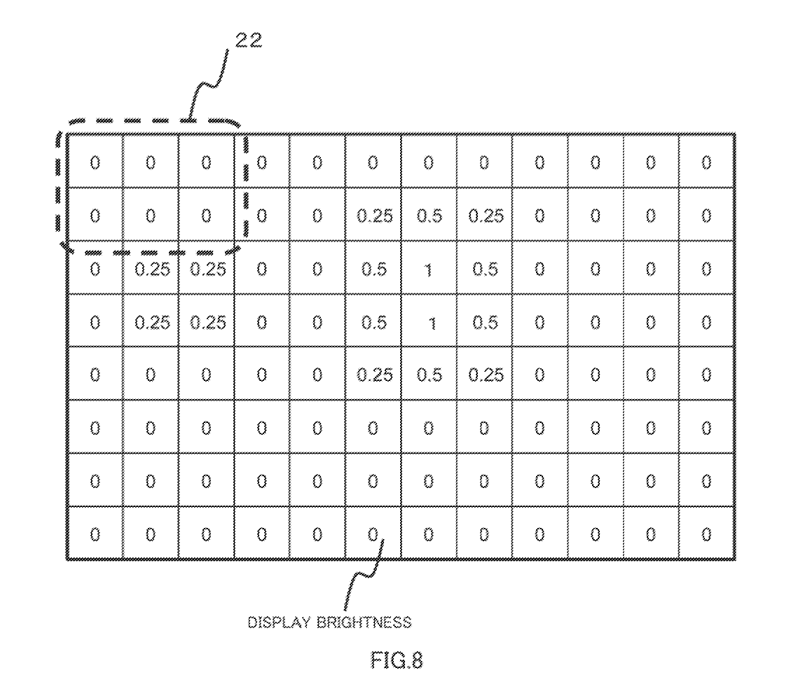

The rectangular pattern shown in FIG. 7 shows the transmittance in each pixel as shown in FIG. 8. With the rectangular pattern shown in FIG. 7, the brightnesses in the pixels in the third row, seventh column and the fourth row, seventh column are the highest, and the brightnesses decreases in the surrounding of these pixels. Assume that the transmittance of an image signal is set to 1 with respect to the maximum light emission brightness of 255, and is set to 0 with respect to the non-light emission state of 0.

<1-2-1. Light Emitting Operation of Backlight Section>

First, the transmittance shown in FIG. 8 is received as input in backlight controlling section 41, and brightness signals that define the light emission ratios are generated for a plurality of light emitting areas provided in backlight section 20.

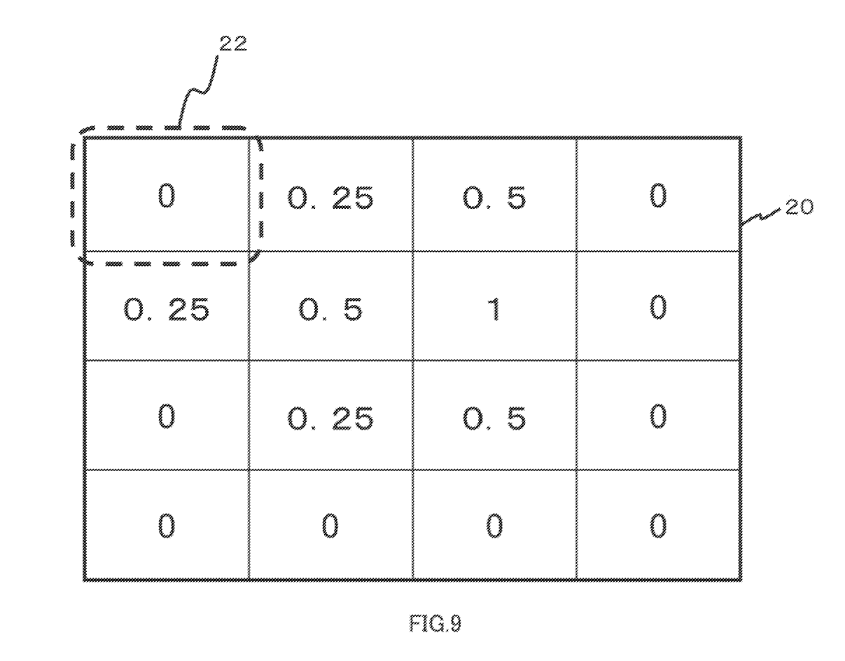

FIG. 9 shows brightness signals generated based on the transmittance shown in FIG. 8.

The brightness signals shown in FIG. 9 are inputted in backlight driver 30, and light emission control signals are generated based on these brightness signals. Then, light sources 21 in backlight section 20 are driven based on the generated light emission control signals, so that backlight section 20 emits light.

<1-2-2. Division of Brightness Signal and Filter Processing Operation>

First, brightness signals generated in backlight controlling section 41 are inputted in block memory controlling section 421.

Then, block memory controlling section 421 performs control to temporarily store the input brightness signals in block memory 422.

Further, when the brightness signals are stored completely, block memory controlling section 421 outputs the brightness signals of each light emitting area 22 accumulated in block memory 422, to subblock segmenting section 423.

Next, subblock segmenting section 423 segments light emitting area 22 into subblocks, and calculates a brightness signal per subblock.

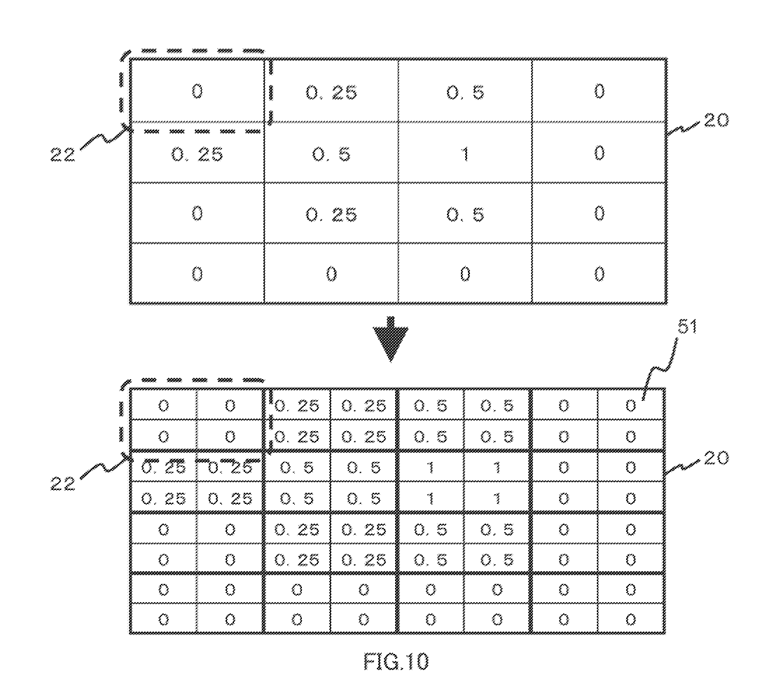

FIG. 10 shows segmentation of light emitting area 22 by subblock segmenting section 423, and numerical examples of brightness signal calculation.

With the numerical examples shown in FIG. 10, subblock segmenting section 423 segments one light emitting area 22 into four subblocks 51 first. Further, based on sixteen brightness signals set for light emitting areas 22, sixty four brightness signals corresponding to subblocks 51 are generated. With the numerical examples in <1-2-2>, the value of the brightness signal set in light emitting area 22 is used as is.

Next, subblock segmenting section 423 outputs the calculated brightness signal of each subblock, to subblock memory controlling section 424.

Then, subblock memory controlling section 424 performs control to temporarily store the input brightness signal of each subblock, in subblock memory 425.

Next, when the brightness signal is stored completely, subblock memory controlling section 424 outputs the brightness signal of each subblock that is accumulated in subblock memory 425, to brightness distribution filter section 426.

Next, by performing filter processing of the brightness signal of each subblock received as input from subblock memory controlling section 424, brightness distribution filter section 426 calculates the brightness signal of each subblock taking into account leakage of light from other light emitting areas.

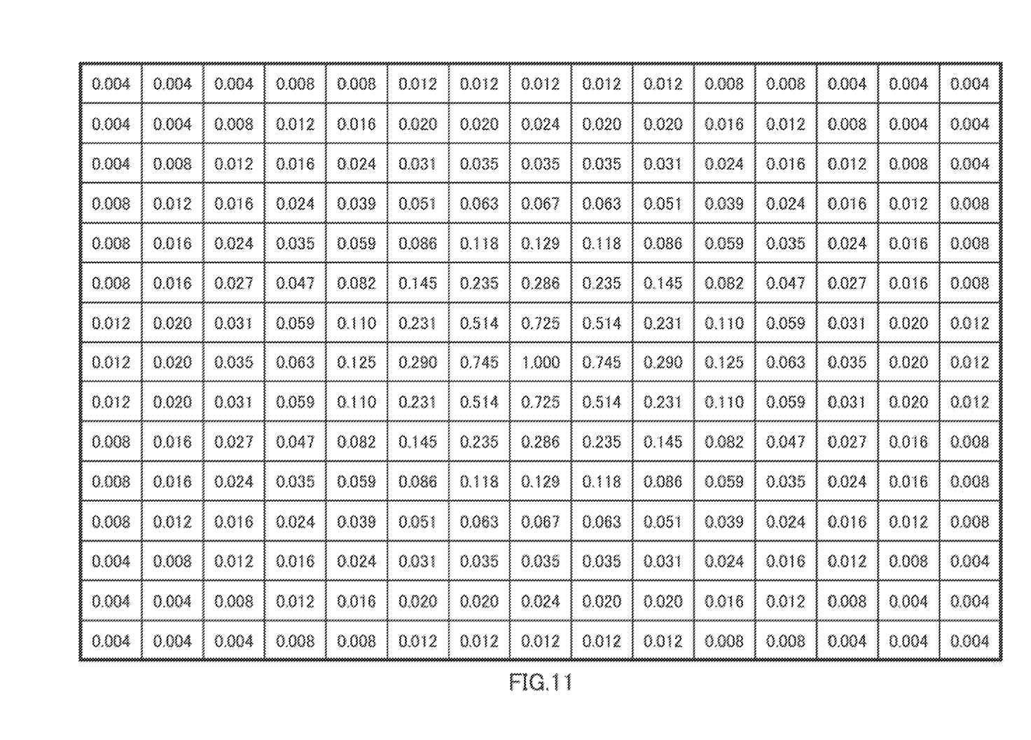

FIG. 11 shows numerical examples of a filter used in brightness distribution filter section 426.

The filter coefficients shown in FIG. 11 are values determined by, for example, the method of disposing light sources 21 inside backlight section 20, and have light emission characteristics with the present embodiment that light spreads uniformly in the vertical direction and the horizontal direction. Using this filter, filter processing is performed with respect to the brightness signal calculated per subblock.

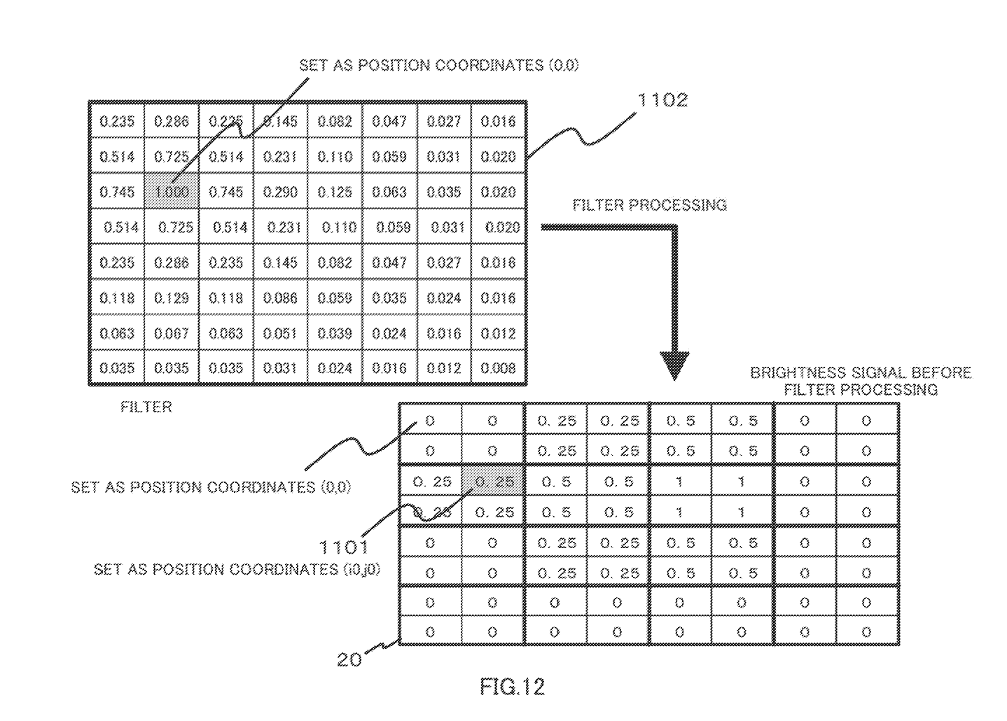

FIG. 12 illustrates filter processing performed per subblock. Here, with the filter shown in FIG. 11, the position coordinates of filter coefficient 1.000 are set to (0,0). Further, the position coordinates of a subblock that is subjected to filter processing are set to (i0,j0). Furthermore, as shown in FIG. 12, the position coordinates of the upper left subblock in backlight section 20 are set to (0,0). Still further, a brightness signal of a subblock is L(i,j) and the filter coefficient of the filter shown in FIG. 11 is F(i,j). Moreover, the brightness signal in the subblock after filter processing is tilde L(i,j).

In case where the setting is made as described above, brightness signal tilde L(i₀, i₀) after filter processing can be calculated based on equation 2.

$$\begin{matrix}( Equation 2 ) & \\ \tilde{L} ( {i}_{0} , {j}_{0} ) = \frac{1}{{\tilde{L}}_{max}} {\sum }_{i = 0}^{2} {\sum }_{j = 0}^{2} ( F ( i - {i}_{0} , j - {j}_{0} ) L ( i , j ) ) & [ 2 ]\end{matrix}$$

Here, tilde Lₘₐₓ is the maximum value of the light emission brightness value in case where all light sources 21 emit light at the maximum brightness value. That is, each brightness signal of subblocks is regularized with respect to tilde Lₘₐₓ. Note that tilde Lₘₐₓ is not limited to the case where all light sources 21 emit light at the maximum brightness value, and may be in the range of brightness values that can be actually radiated by the backlight section.

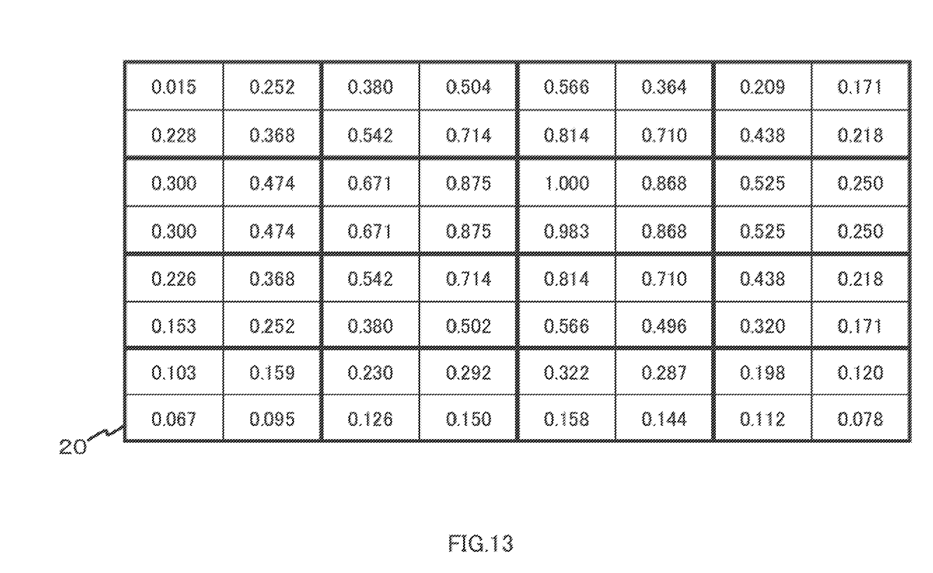

If brightness signals of subblocks are calculated using equation 2, these brightness signals show values shown in FIG. 13. The brightness signal of each subblock after filter processing is inputted in interpolating section 427.

When the brightness signal of each subblock after filter processing is received as input, interpolating section 427 calculates an estimated light emission brightness value in a pixel based on this brightness signal.

Next, signal correcting section 43 performs gamma conversion of the input estimated light emission brightness value, and inputs the gamma converted signal to image correcting section 44.

Image correcting section 44 generates the transmittance of pixels in liquid crystal panel 10, based on the input estimated light emission brightness value.

<1-3. Conclusion>

As described above, according to the present embodiment, the brightness values of light arriving at the pixels in liquid crystal panel 10 are estimated based on brightness signals outputted from backlight controlling section 41. In this estimation, based on the first brightness signal generated in backlight controlling section 41, the second brightness signal is generated per subblock acquired by segmenting light emitting area 22, and filter processing is further performed with respect to the second brightness signal. Consequently, it is possible to estimate brightness values taking brightness characteristics of virtual light sources 23 into account in more details than light emitting areas 22 units. Accordingly, when the display brightness of an input image signal is corrected, an adequate transmittance can be set per pixel, so that, compared to conventional liquid crystal display apparatuses, it is possible to display high-quality images even in case where the light emission of backlight section 20 is controlled per area.

Further, according to the present embodiment, the size of subblocks is set larger than pixels. In other words, although the unit of filter processing (i.e. subblock) is finer than the unit of light emission brightness value control in backlight section 20 (i.e. light emitting area), it is more coarse than the unit of brightness estimation of light arriving at pixels (i.e. pixel). Accordingly, it is possible to suppress a substantial increase in processing load due to filter processing.

### Embodiment 2

Hereinafter, Embodiment 2 of the present invention will be explained. The brightness filter section explained in <1-1-4-2-6> employs a configuration for performing filter processing using a two-dimensional filter taking light emission brightness in virtual light source 23 into account.

However, in case where filter processing is performed using a two-dimensional filter in the brightness distribution filter section, the amount of computation required for the number of subblocks n set in backlight section 20 is n×n.

Hence, the characteristics of the present embodiment include that, when the brightness distribution filter section performs filter processing of a brightness signal set per subblock, a horizontal one-dimensional filter and a vertical one-dimensional filter are used.

With the above configuration, in case where, for example, filter processing is performed with respect to the number of subblocks n set in backlight section 20, it is possible to reduce the amount of required computation to 2n. Consequently, even a CPU of a comparatively low computation processing speed can set an adequate transmittance per pixel and display high-quality images compared to conventional liquid crystal display apparatuses.

Note that Embodiment 2 differs from the liquid crystal display apparatus of Embodiment 1 in performing filter processing in a brightness distribution filter section using a horizontal one-dimensional filter and a vertical one-dimensional filter. The other configurations are the same.

Note that the same components explained in Embodiment 1 will be assigned the same reference numerals, and will not be explained.

Hereinafter, the above difference from the liquid crystal display apparatus according to Embodiment 1 of the present invention, that is, a configuration of the brightness distribution filter section and filter processing, will be mainly explained with reference to the accompanying drawings.

<2-1. Brightness Distribution Filter Section>

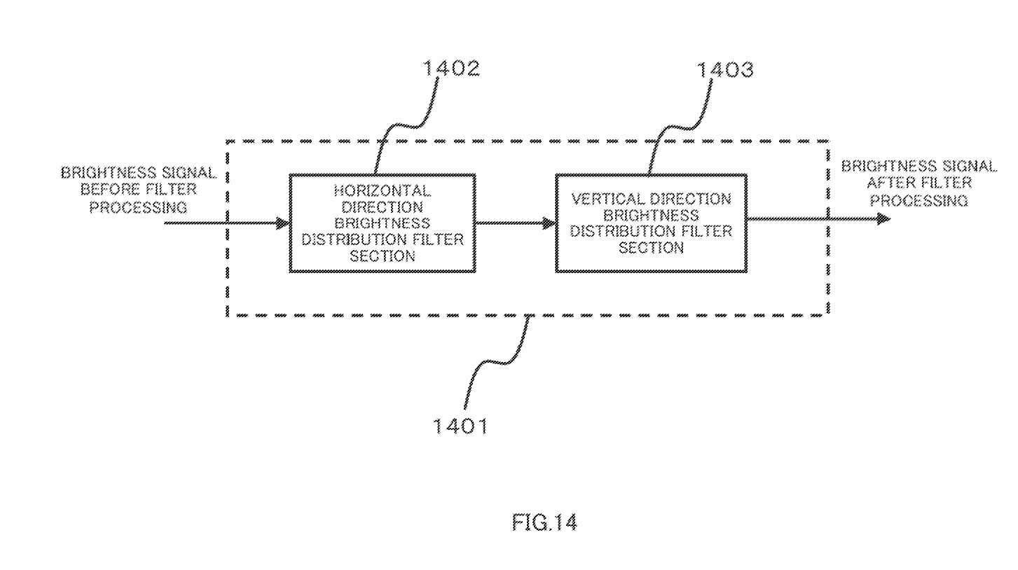

FIG. 14 is a schematic diagram showing a configuration of brightness distribution filter section 1401.

Brightness distribution filter 1401 has horizontal direction brightness distribution filter section 1402 and vertical direction brightness distribution filter section 1403.

<2-1-1. Horizontal Direction Brightness Distribution Filter Section>

Based on segmentation information and a brightness signal of each subblock received as input from subblock memory controlling section 424, horizontal direction brightness distribution filter section 1402 performs filter processing of the brightness signal in the horizontal direction. Further, horizontal direction brightness distribution filter section 1402 outputs the brightness signal of each subblock acquired from this filter processing, to vertical direction brightness distribution filter section 1403.

The filter that performs filter processing is set as a one-dimensional filter, and has horizontal brightness distribution characteristics of virtual light source 23. That is, by performing filter processing of the brightness signal calculated per subblock using this filter, it is possible to convert the brightness signal into a brightness signal taking into account the influence of virtual light source 23 of interest in the horizontal direction of the brightness signal and, in addition, the influence of the virtual sources disposed around virtual light source 23 of interest in the horizontal direction. Here, the influence from virtual light sources disposed around the virtual light source of interest refers to, for example, light leaking from neighboring light emitting areas, and, in case where light sources 21 are LEDs, refers to the influence of light diffusion characteristics of LED lenses.

Note that the filter size may be set according to the number of segments, and set to a size greater than the number of segments. For example, in case where backlight section 20 is segmented into subblocks of eight rows and eight columns, the filter size is set to a size of one row and fifteen columns.

Further, the filter used in horizontal direction brightness distribution filter section 1402 may be held in this horizontal direction brightness distribution filter section 1402, or may be held in an external memory so as to be read when filter processing is performed.

<2-1-2. Vertical Direction Brightness Distribution Filter Section>

Based on a brightness signal of each subblock that is received as input from horizontal direction brightness distribution filter section 1402 and that is subjected to filter processing in the horizontal direction, vertical direction brightness distribution filter section 1403 performs filter processing of this brightness signal in the vertical direction. Further, vertical direction brightness distribution filter section 1403 outputs the brightness signal of each subblock acquired from this filter processing, to interpolating section 427.

The filter that performs filter processing is set as a one-dimensional filter, and has vertical brightness distribution characteristics of virtual light source 23. That is, by performing filter processing of the brightness signal calculated per subblock using this filter, it is possible to convert the brightness signal into a brightness signal taking into account the influence of virtual light source 23 of interest in the vertical direction of the brightness signal and, in addition, the influence of the virtual sources disposed around virtual light source 23 of interest in the vertical direction. Here, the influence from virtual light sources disposed around the virtual light source of interest refers to, for example, light leaking from neighboring light emitting areas, and, in case where light sources 21 are LEDs, refers to the influence of light diffusion characteristics of LED lenses.

Note that the filter size may be set according to the number of segments, and set to a size greater than the number of segments. For example, in case where backlight section 20 is segmented into subblocks of eight rows and eight columns, the filter size is set to the size of fifteen rows and one column.

Further, the filter used in vertical direction brightness distribution filter section 1403 may be held in this vertical direction brightness distribution filter section 1403, or may be held in an external memory so as to be read when filter processing is performed.

<2-2. Operation of Brightness Distribution Filter Section>

Next, a specific operation example of brightness distribution filter section 1401 employing the above configuration will be explained with reference to the accompanying drawings. Assume that, with the present embodiment, light radiated from virtual light sources 23 is not reflected in the surrounding of backlight section 20.

First, horizontal direction brightness distribution filter section 1402 receives brightness signals set for sixty four subblocks shown in FIG. 10, as input from subblock memory controlling section 424.

Next, horizontal direction brightness distribution filter section 1402 performs filter processing of the input brightness signal of each subblock using the filter having the horizontal light emission characteristics.

Hereinafter, filter processing in horizontal direction brightness distribution filter section 1402 will be explained in detail with reference to the accompanying drawings.

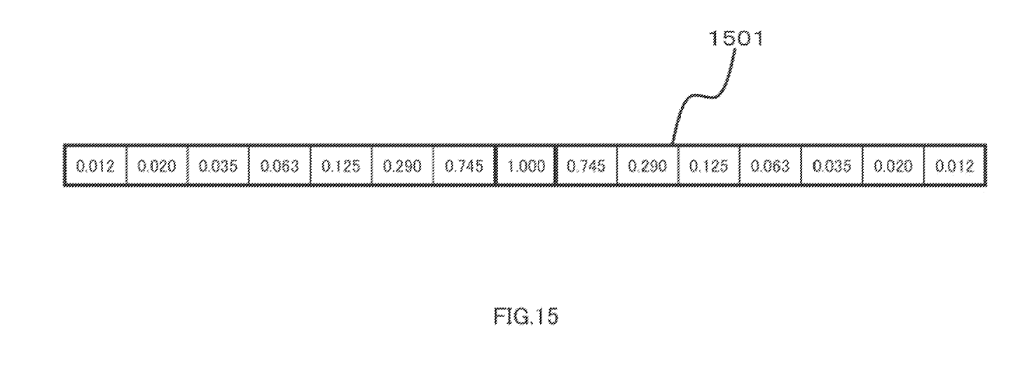

FIG. 15 illustrates the filter having horizontal light emission characteristics.

The filter coefficients shown in FIG. 15 are values determined by, for example, the method of disposing light sources 21 inside backlight section 20, and have light emission characteristics with the present embodiment that light is dimmed while spreading in the horizontal direction. Using this filter, filter processing is performed with respect to the brightness signal calculated per subblock.

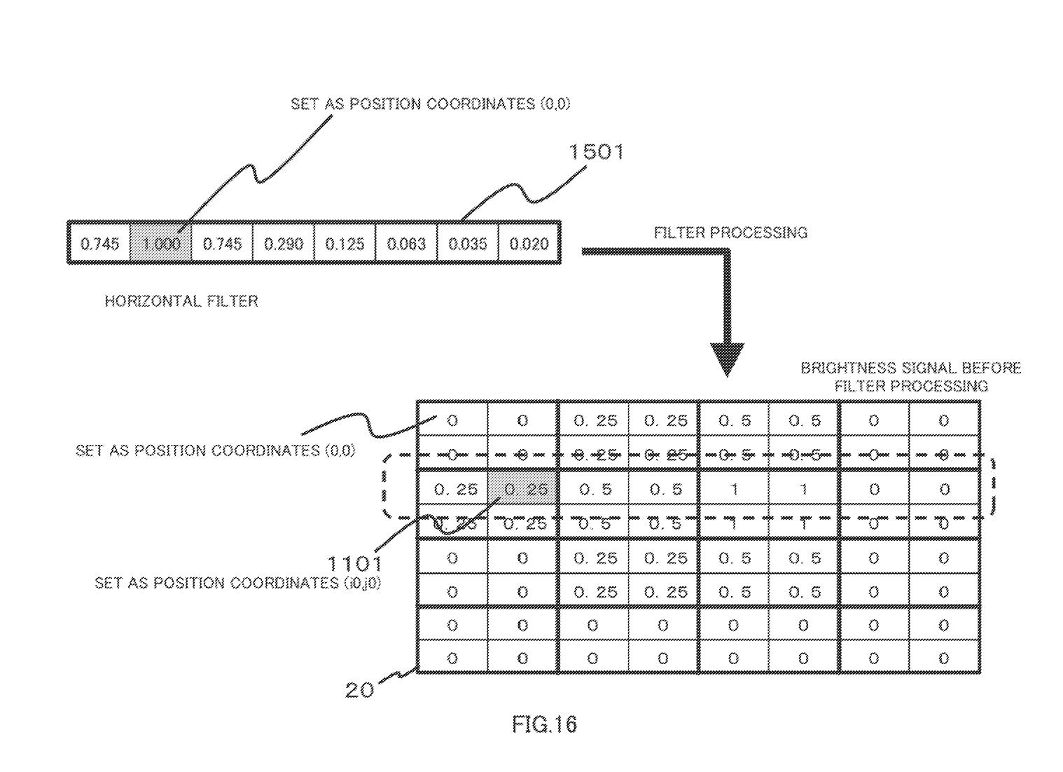

FIG. 16 illustrates filter processing performed per subblock. Here, with the filter shown in FIG. 15, the position coordinates of filter coefficient 1.000 are set to (0,0). Further, the position coordinates of a subblock that are subjected to filter processing are set to (i0,j0). Furthermore, as shown in FIG. 16, the position coordinates of the upper left subblock in backlight section 20 are set to (0,0). Still further, a brightness signal of a subblock is L(i,j) and the filter coefficient of the filter shown in FIG. 15 is Fh(0,j). Moreover, the brightness signal in the subblock after filter processing using the horizontal filter is tilde Lₕ(i,j).

In case where the setting is made as described above, brightness signal tilde Lₕ(i₀,j₀) after filter processing using a horizontal filter can be calculated based on equation 3.

$$\begin{matrix}( Equation 3 ) & \\ {\tilde{L}}_{h} ( {i}_{0} , {j}_{0} ) = {\sum }_{j = 0}^{7} ( {F}_{h} ( 0 , j - {j}_{0} ) L ( {i}_{0} , j ) ) & [ 3 ]\end{matrix}$$

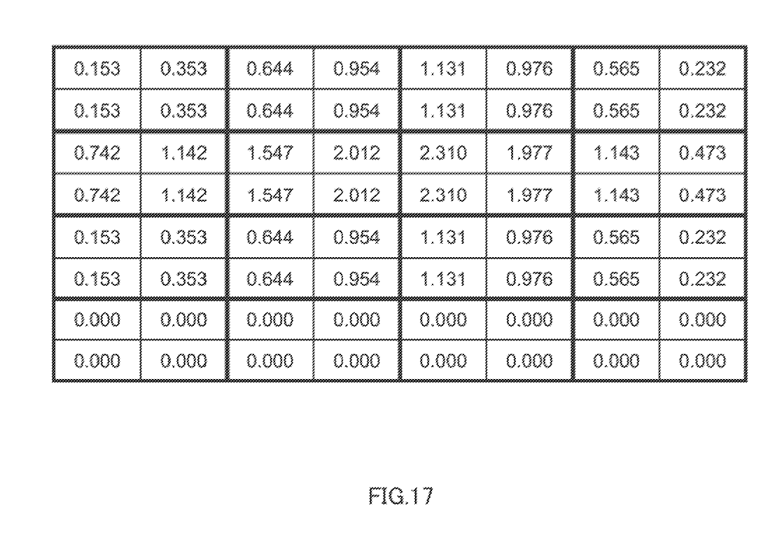

If brightness signals of subblocks are calculated using equation 3, these brightness signals show values shown in FIG. 17. The brightness signal of each subblock after filter processing is received as input in vertical direction brightness distribution filter section 1403.

Next, vertical direction brightness distribution filter section 1403 performs filter processing of the input brightness signal of each subblock using the filter having the vertical light emission characteristics.

Hereinafter, filter processing in horizontal direction brightness distribution filter section 1402 will be explained in detail with reference to the accompanying drawings.

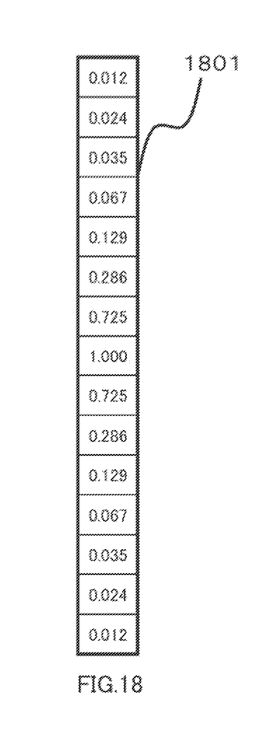

FIG. 18 illustrates the filter having vertical light emission characteristics.

The filter coefficients shown in FIG. 18 are values determined by, for example, the method of disposing light sources 21 inside backlight section 20, and have light emission characteristics with the present embodiment that light is dimmed while spreading in the vertical direction. Using this filter, filter processing is performed with respect to the brightness signal calculated per subblock.

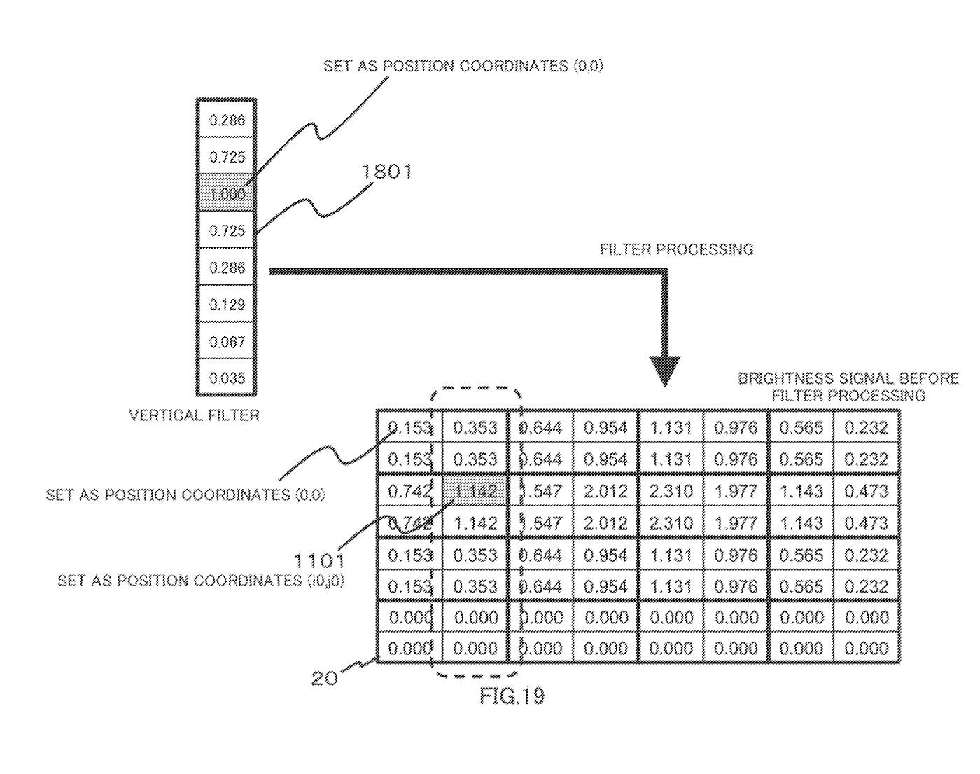

FIG. 19 illustrates filter processing performed per subblock. Here, with the filter shown in FIG. 18, the position coordinates of filter coefficient 1.000 are set to (0,0). Further, the position coordinates of a subblock that is subjected to filter processing are set to (i0,j0). Furthermore, as shown in FIG. 19, the position coordinates of the tipper left subblock in backlight section 20 are set to (0,0). Still further, a brightness signal of a subblock is tilde Lₕ(i,j) and the filter coefficient of the filter shown in FIG. 15 is Fv(i,0). Moreover, the brightness signal in the subblock after filter processing using the horizontal filter is tilde L(i,j).

In case where the setting is made as described above, brightness signal tilde L(i₀,j₀) after filter processing using the vertical filter can be calculated based on equation 4.

$$\begin{matrix}( Equation 4 ) & \\ \tilde{L} ( {i}_{0} , {j}_{0} ) = \frac{1}{{\tilde{L}}_{max}} {\sum }_{i = 0}^{7} ( {F}_{v} ( i - {i}_{0} , 0 ) {\tilde{L}}_{h} ( i , {j}_{0} ) ) & [ 4 ]\end{matrix}$$

Here, tilde Lₘₐₓ is the maximum value of the light emission brightness value in case where all light sources 21 emit light at the maximum brightness value. That is, each brightness signal of subblocks is regularized with respect to tilde Lₘₐₓ. Note that tilde Lₘₐₓ is not limited to the case where all light sources 21 emit light at the maximum brightness value, and may be in the range of brightness values that can be actually radiated by the backlight section.

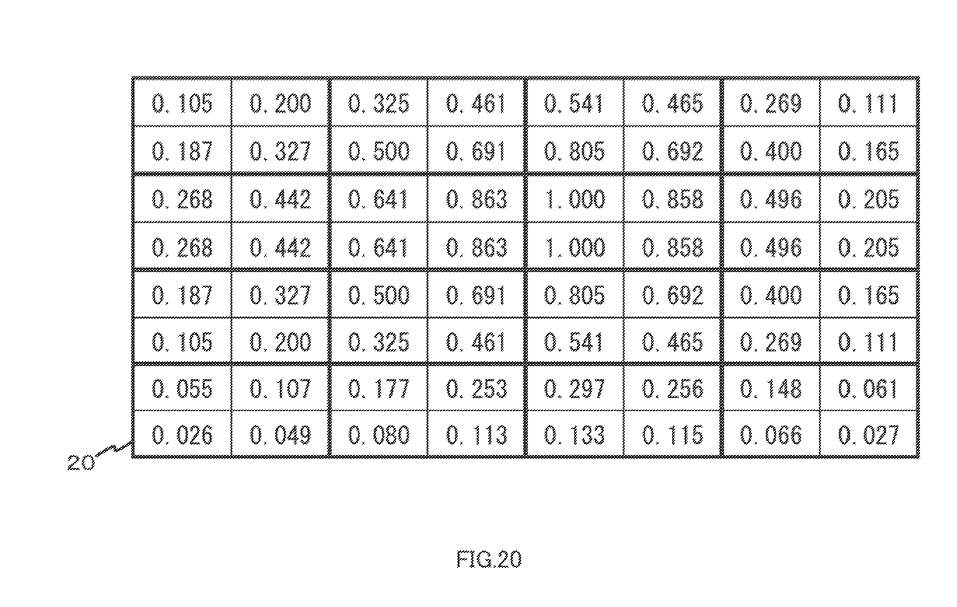

If brightness signals of subblocks are calculated using equation 4, these brightness signals show values shown in FIG. 20. The brightness signal of each subblock after filter processing is received as input in interpolating section 427.

The subsequent processings are the same as in Embodiment 1 of the present invention, and therefore will not be explained.

<2-3. Conclusion>

As described above, according to the present embodiment, brightness values of light arriving at the pixels in liquid crystal panel 10 are estimated based on brightness signals outputted from backlight controlling section 41. In this estimation, the brightness distribution filter section performs filter processing of the brightness signal set per subblock using the horizontal one-dimensional filter and the vertical one-dimensional filter. By using the one-dimensional filters, it is possible to reduce the amount of computation of filter processing of the number of subblocks n set in backlight section 20 compared to the filter processing using two-dimensional filters. Consequently, even a CPU of a comparatively low computation processing speed can set an adequate transmittance per pixel and display high-quality images compared to conventional liquid crystal display apparatuses.

Note that, although the configuration has been explained with Embodiment 2 of the present invention where filter processing is performed in the horizontal direction and then filter processing is performed in the vertical direction, a reverse configuration is equally possible.

### Embodiment 3

Hereinafter, Embodiment 3 of the present invention will be explained. The brightness distribution filter section explained in <1-1-4-2-6> employs a configuration for performing filter processing using a two-dimensional filter taking into account the light emission brightness in virtual light source 23.

However, in case where filter processing is performed using a two-dimensional filter in the brightness distribution filter section, the amount of computation required for the number of subblocks n set in backlight section 20 is n×n.

Hence, with the present embodiment, a first brightness distribution filter section performs filter processing of a brightness signal set per light emitting area, and a second brightness distribution filter section performs filter processing of a brightness signal set per subblock. Here, characteristics of the present embodiment include that the first brightness distribution filter section performs, on a large scale, filter processing of a brightness signal before it is segmented into subblocks. Further, the characteristics of the present embodiment include that the second brightness distribution filter section locally performs filter processing of a brightness signal after it is segmented into subblocks. With this configuration, it is possible to reduce the amount of filter processing performed by the liquid crystal display apparatus. Consequently, even a CPU of a comparatively low computation processing speed can set an adequate transmittance per pixel and display high-quality images compared to conventional liquid crystal display apparatuses.

To be more specific, a case is assumed where backlight section 20 in which a brightness signal is set per light emitting area segmented into sixteen subblocks of four rows and four columns, is segmented into sixty four subblocks, and filter processing is performed with respect to brightness signals after the segmentation, using the filter of three rows and three columns. In this case, the total amount of computation required in filter processing is 256+64×9=832. Note that, in case where the filter of eight rows and eight columns is used for the brightness signals segmented into sixty four subblocks, the total amount of computation is 64×64=4096. Consequently, it is possible to reduce the amount of computation to about one fifth.

Further, the difference from the liquid crystal display apparatuses of Embodiments 1 and 2 is that the brightness estimating section has the first brightness distribution filter section and the second brightness distribution filter section.

Further, the same components as in Embodiments 1 and 2 will be assigned the same reference numerals, and will not be explained.

Hereinafter, the difference of the liquid crystal display apparatus according to the present embodiment will be mainly explained with reference to the accompanying drawings.

<3-1. Brightness Estimating Section>

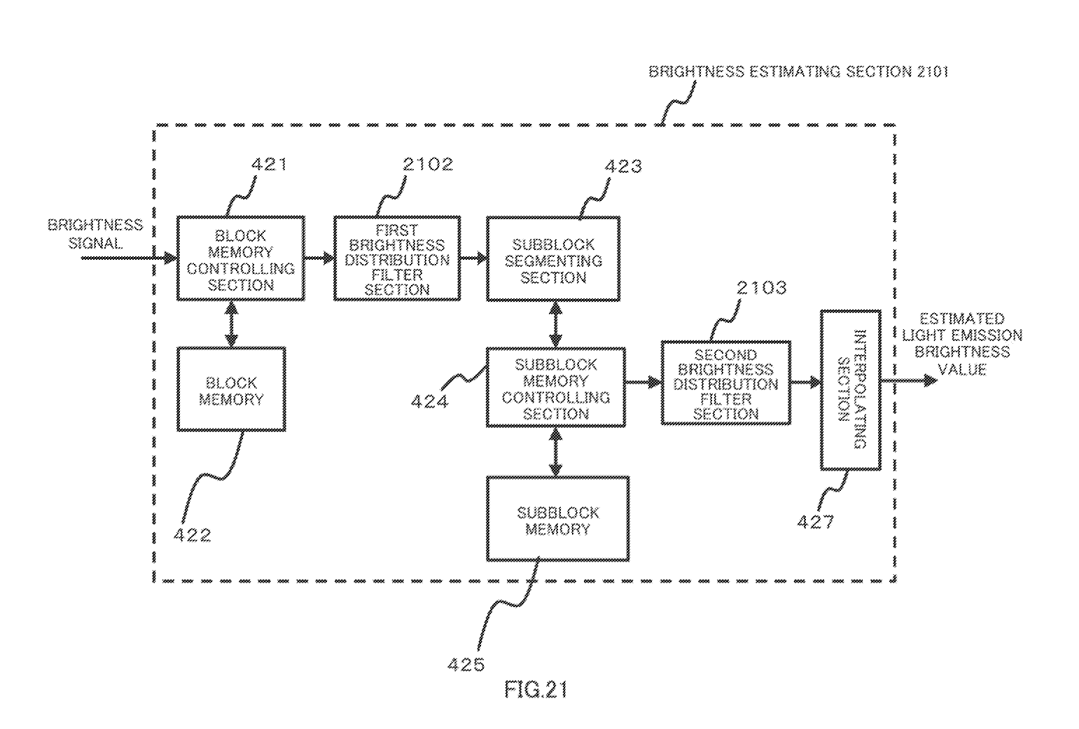

FIG. 21 is a schematic diagram showing brightness estimating section 2101 according to the present embodiment. Brightness estimating section 2101 has first brightness distribution filter section 2102 and second brightness distribution filter section 2103.

<3-1-1. First Brightness Distribution Filter Section>

First brightness distribution filter section 2102 performs filter processing of a brightness signal of each light emitting area received as input from block memory controlling section 421. Further, first brightness distribution filter section 2012 outputs the brightness signal of each light emitting area acquired from this filter processing, to subblock segmenting section 423.

The filter that performs this filter processing is set as a two-dimensional filter, and has large scale brightness distribution characteristics of virtual light source 23. That is, by performing filter processing of the brightness signal calculated per light emitting area using this filter, it is possible to convert the brightness signal into a brightness signal taking into account the influence of virtual light source 23 of interest upon the brightness signal and, in addition, the influence of the virtual sources disposed on large scale around virtual light source 23 of interest. Here, the influence from virtual light sources disposed around the virtual light source of interest refers to, for example, light leaking from neighboring light emitting areas, and, in case where light sources 21 are LEDs, refers to the influence of light diffusion characteristics of LED lenses.

Note that the filter size may be set according to the number of light emitting areas, or may be set larger than the number of light emitting areas. For example, in case where light emitting areas of four rows and four columns in backlight section 20 are controlled, the filter size is set to the size of seven rows and seven columns.

Further, the filter used in first brightness distribution filter section 2102 may be held in this first brightness distribution filter section 2102, or may be held in an external memory so as to be read when filter processing is performed.

<3-1-2. Second Brightness Distribution Filter Section>

Second brightness filter section 2103 performs filter processing of a brightness signal of each subblock received as input from subblock memory controlling section 424. Further, second brightness distribution filter section 2103 outputs the brightness signal of each subblock acquired from this filter processing, to interpolating section 427.

The filter that performs this filter processing is set as a two-dimensional filter, and has local brightness distribution characteristics of virtual light source 23. That is, by performing filter processing of the brightness signal calculated per subblock using this filter, it is possible to convert the brightness signal into a brightness signal taking into account the influence of virtual light source 23 of interest upon the brightness signal and, in addition, the influence of the virtual sources disposed locally around virtual light source 23 of interest. Here, the influence from virtual light sources disposed around the virtual light source of interest refers to, for example, light leaking from neighboring light emitting areas, and, in case where light sources 21 are LEDs, refers to the influence of light diffusion characteristics of LED lenses.

Further, the filter size set in second brightness distribution filter section 2103 is smaller than the filter size set in first brightness distribution filter section 2102. The large scale light emission characteristics of virtual light sources are taken into account in first brightness distribution filter section 2012, so that, even if a filter of a smaller size is used in second brightness distribution filter section 2103, it is possible to adequately calculate brightness signals taking into account the influence of virtual light sources disposed in the surrounding.

Further, the filter used in second brightness distribution filter section 2103 may be held in this second brightness distribution filter section 2103, or may be held in an external memory so as to be read when filter processing is performed.

<3-2. Division of Brightness Signal and Filter Processing Operation>

First, brightness signals generated in backlight controlling section 41 are inputted in block memory controlling section 421.

Then, block memory controlling section 421 performs control to temporarily store the input brightness signals in block memory 422.

Further, when the brightness signals are stored completely, block memory controlling section 421 outputs the brightness signals of each light emitting area 22 accumulated in block memory 422, to first brightness distribution filter section 2102.

Next, first brightness distribution filter section 2102 performs filter processing of the brightness signals of each light emitting area, using the filter having the large scale brightness distribution characteristics of virtual light source 23.

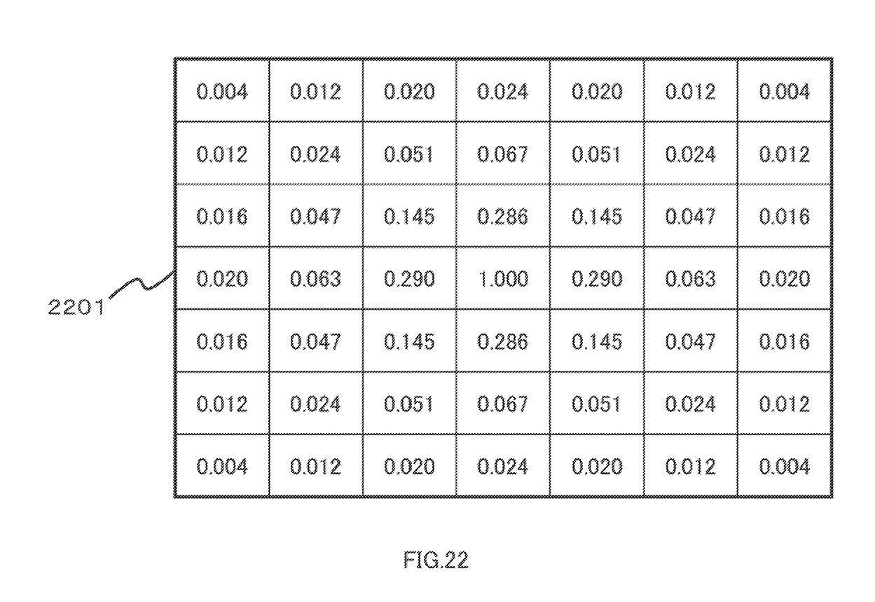

FIG. 22 shows filter 2201 used in first brightness distribution filter section 2102.

The large scale light emission characteristics of light emitting areas are taken into account, and therefore filter 2201 shown in FIG. 22 has light emission characteristics that the filter coefficients decrease as the distance is farther apart from 1.000 (i.e. the center portion of the filter). Further, the filter size is a size that allows influences of all virtual light sources 23 set in backlight section 20 to be taken into account. With the present embodiment, backlight section 20 is segmented into light emitting areas of four rows and four columns, and therefore first brightness distribution filter section 2102 has the filter of seven rows and seven columns.

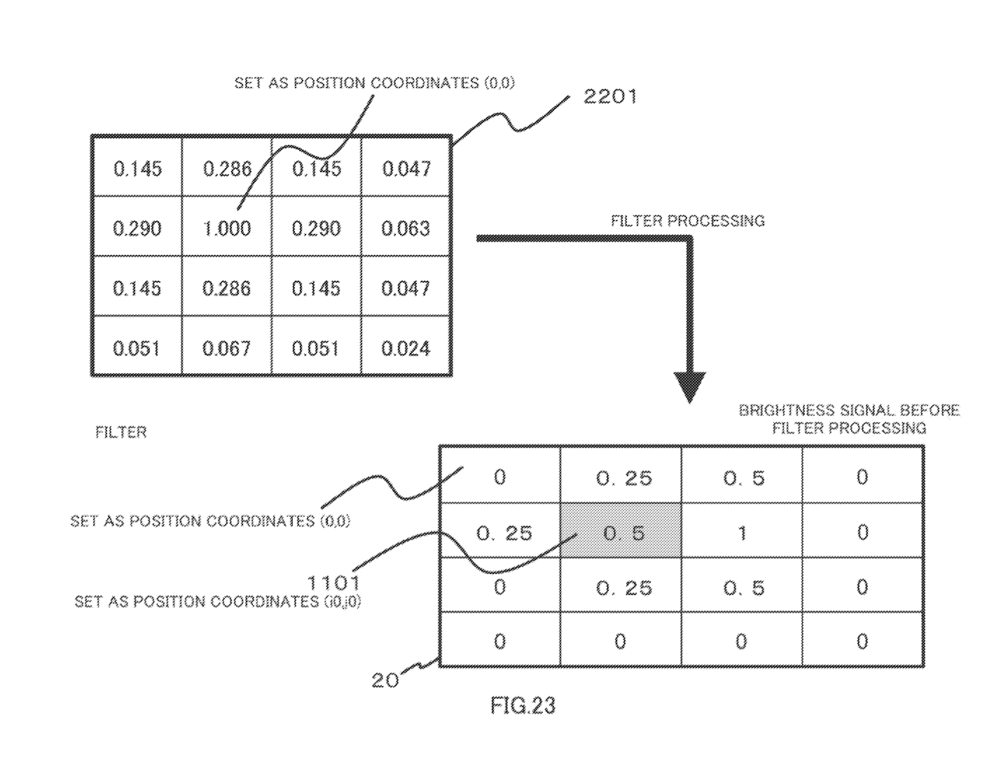

FIG. 23 illustrates filter processing performed per light emitting area. Here, with the filter shown in FIG. 22, the position coordinates of filter coefficient 1.000 are set to (0,0). Further, the position coordinates of a light emitting area that is subjected to filter processing are set to (i0,j0). Furthermore, as shown in FIG. 23, the position coordinates of the upper left light emitting area in backlight section 20 are set to (0,0). Still further, a brightness signal of a light emitting area before filter processing is L₁ and the filter coefficient of filter 2201 shown in FIG. 22 is F1(i,j). Moreover, the brightness signal in the subblock after filter processing using filter 2201 is tilde L₁.

In case where the setting is made as described above, brightness signal tilde L₁ after filter processing using filter 2201 can be calculated based on equation 5.

$$\begin{matrix}( Equation 5 ) & \\ {\tilde{L}}_{l} ( {i}_{0} , {j}_{0} ) = {\sum }_{i = 0}^{3} {\sum }_{j = 0}^{3} ( {F}_{1} ( i - {i}_{0} , j - {j}_{0} ) {L}_{l} ( i , j ) ) & [ 5 ]\end{matrix}$$

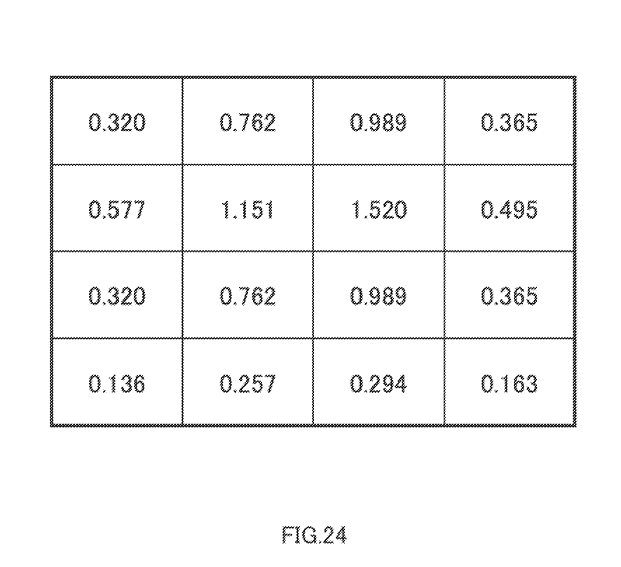

Actually, in case where the brightness signals shown in FIG. 9 are received as input, the brightness signals outputted from first brightness distribution filter section 2102 become the brightness signals shown in FIG. 24. These brightness signals become brightness signals that take into account light leaking from virtual light sources 23 in the surrounding.

First brightness distribution filter section 2102 outputs the brightness signals subjected to filter processing, to subblock segmenting section 423.

Next, subblock segmenting section 423 segments light emitting area 22 into subblocks, and calculates a brightness signal per subblock.

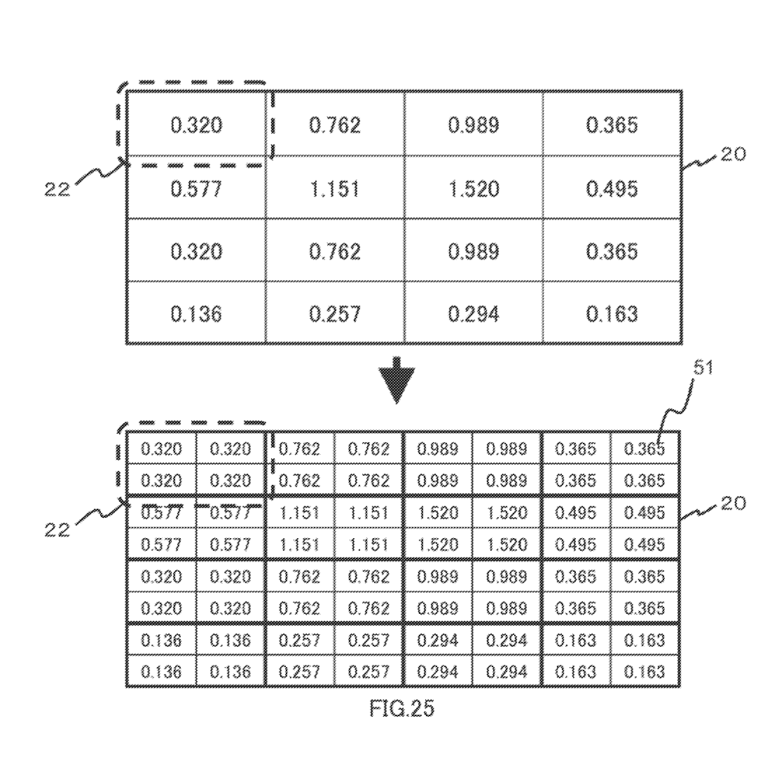

FIG. 25 shows segmentation of light emitting area 22 by subblock segmenting section 423, and numerical examples of brightness signal calculation.

With the numerical examples shown in FIG. 25, subblock segmenting section 423 segments one light emitting area 22 into four subblocks first. Further, based on sixteen brightness signals set for light emitting areas 22, sixty four brightness signals corresponding to subblocks are generated. Furthermore, with the present embodiment, the value of the brightness signal set in light emitting area 22 is used as is.

Next, subblock segmenting section 423 outputs the calculated brightness signal of each subblock, to subblock memory controlling section 424.

Then, subblock memory controlling section 424 performs control to temporarily store the input brightness signal of each subblock, in subblock memory 425.

Next, when the brightness signal is stored completely, subblock memory controlling section 424 outputs the brightness signals of each subblock that are accumulated in subblock memory 425, to second brightness distribution filter section 426.

Next, second brightness distribution filter section 2103 performs filter processing of the brightness signal of each subblock received as input from subblock memory controlling section 424, using a filter that takes the local light emission characteristics into account. By this means, second brightness distribution filter section 2103 calculates the brightness signal of each subblock taking into account leakage of light from other light emitting areas.

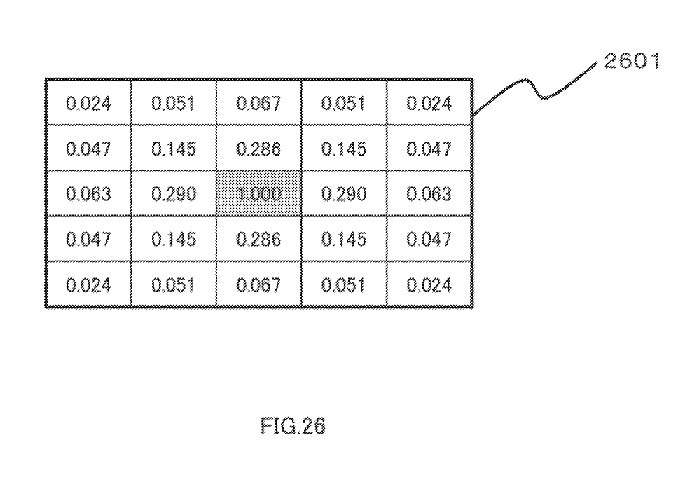

FIG. 26 shows numerical examples of a filter used in second brightness distribution filter section 2103.

The filter coefficients shown in FIG. 26 are values determined by, for example, the method of disposing light sources 21 inside backlight section 20, and have light emission characteristics with the present embodiment that light spread uniformly in the vertical direction and the horizontal direction. Using this filter, filter processing is performed with respect to the brightness signal calculated per subblock. Further, the filter size is a size that takes into account only local areas of all subblocks. With the present embodiment, this size takes into account up to the subblock two subblocks ahead of the subblock of interest.

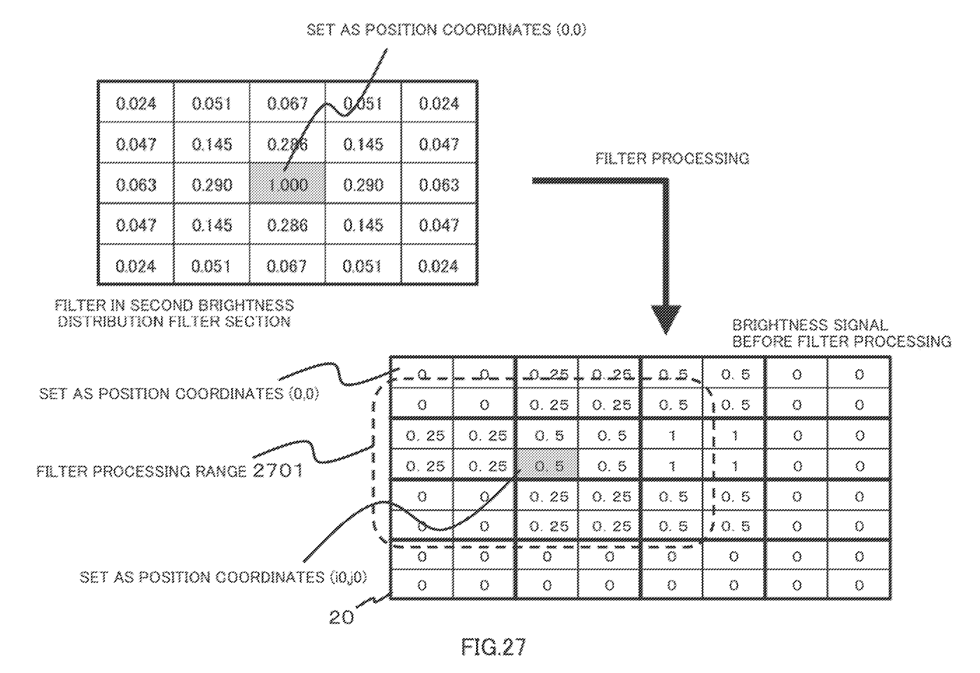

FIG. 27 illustrates filter processing performed per subblock. Here, with the filter shown in FIG. 26, the position coordinates of filter coefficient 1.000 are set to (0,0). Further, the position coordinates of a subblock that is subjected to filter processing are set to (i0,j0). Furthermore, as shown in FIG. 27, the position coordinates of the upper left subblock in backlight section 20 are set to (0,0). Still further, a brightness signal of a subblock is tilde L₁(i,j) and the filter coefficient of the filter shown in FIG. 26 is F2(i,j). Moreover, the brightness signal in the subblock after filter processing is tilde L(i,j).

In case where the setting is made as described above, brightness signal tilde L(i₀,j₀) after filter processing can be calculated based on equation 6.

$$\begin{matrix}( Equation 6 ) & \\ \tilde{L} ( {i}_{0} , {j}_{0} ) = \frac{1}{{\tilde{L}}_{max}} {\sum }_{i = 0}^{2} {\sum }_{j = 0}^{2} ( {F}_{2} ( i - {i}_{0} , j - {j}_{0} ) {\tilde{L}}_{l} ( i , j ) ) & [ 6 ]\end{matrix}$$

Here, tilde Lₘₐₓ is the maximum value of the light emission brightness value in case where all light sources 21 emit light at the maximum brightness value. That is, each brightness signal of subblocks is regularized with respect to tilde Lₘₐₓ. Note that tilde Lₘₐₓ is not limited to the case where all light sources 21 emit light at the maximum brightness value, and may be in the range of brightness values that can be radiated actually by the backlight section. Further, regularization based on tilde Lₘₐₓ may be performed not only in second brightness distribution filter section but also in first brightness distribution filter section.

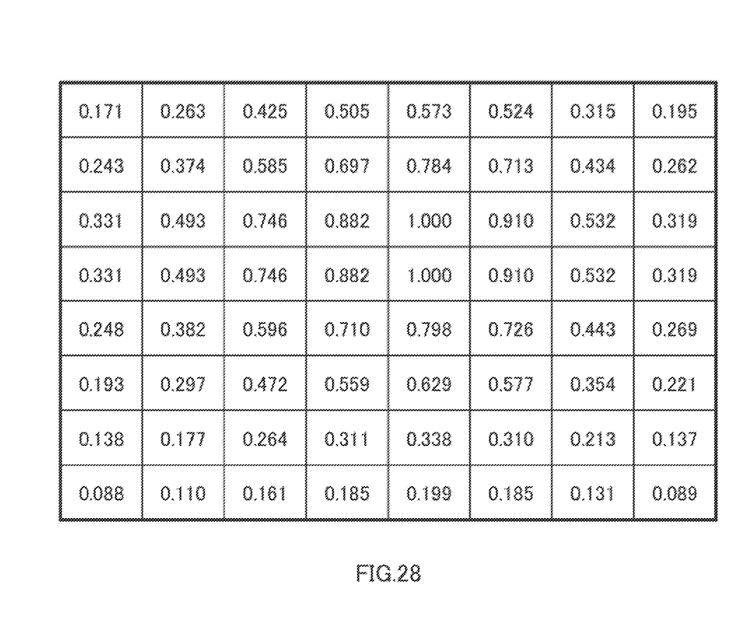

If brightness signals of subblocks are calculated using equation 6, these brightness signals show values shown in FIG. 28. The brightness signal of each subblock after filter processing is received as input in interpolating section 427.

The subsequent processings are the same as in Embodiment 1 of the present invention, and therefore will not be explained.

<3-3. Conclusion>

As described above, according to the present embodiment, after performing filter processing of the first brightness signal outputted from backlight controlling section 41 taking into account a large scale influence of virtual light sources 23 set in back light section 20, a second brightness signal is generated per subblock. Further, filter processing of the second brightness signal is performed taking into account the local influence of virtual light sources 23 to calculate an estimated light emission brightness value. Thus, by using two filters including a large scale filter and a local filter, it is possible to reduce the amount of filter processing performed in the liquid crystal display apparatus. Consequently, even a CPU of a comparatively low computation processing speed can set an adequate transmittance per pixel and display high-quality images compared to conventional liquid crystal display apparatuses.

### Another Embodiment

Hereinafter, another embodiment will be explained.

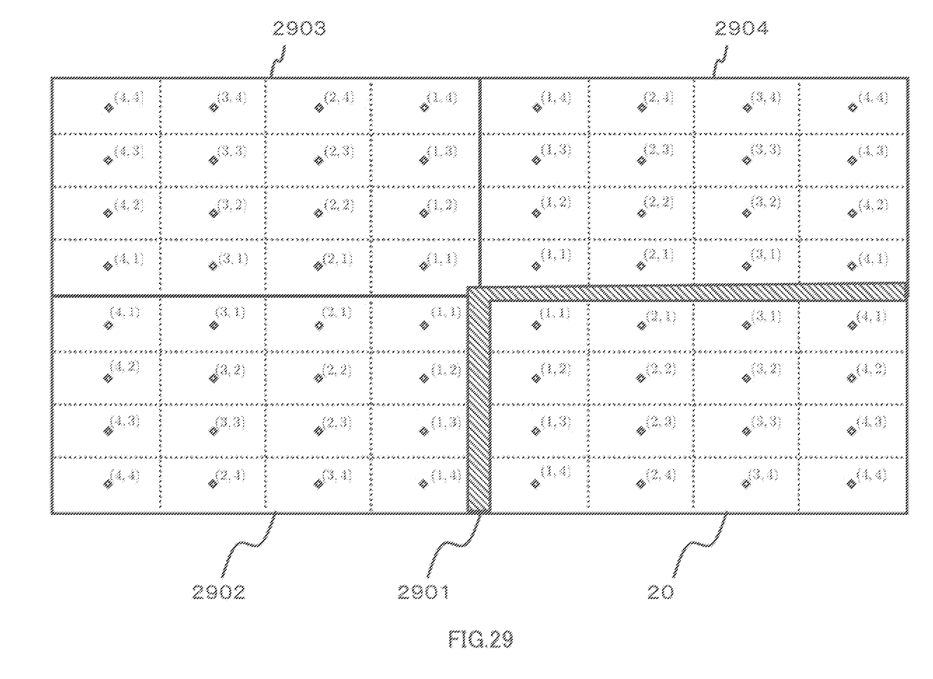

In Embodiments 1 to 3, a configuration is possible where reflecting plate 2901 that reflects illumination light from virtual light sources 23 is provided in the lateral surface part of backlight section 20. FIG. 29 shows a configuration in which reflecting plate 2901 is provided in backlight section 20. In case where reflecting plate 2901 is provided in backlight section 20, backlight section 20 operates as if it were virtually expanded. That is, a configuration is provided in which virtual backlight sections 2902, 2903 and 2904 are provided around backlight section 20.

In this case, filter processing is performed in the same way with respect to backlight sections 2902, 2903 and 2904 that are virtually set.

With the above configuration, it is possible to calculate an estimated light emission brightness value in a pixel of interest more accurately.

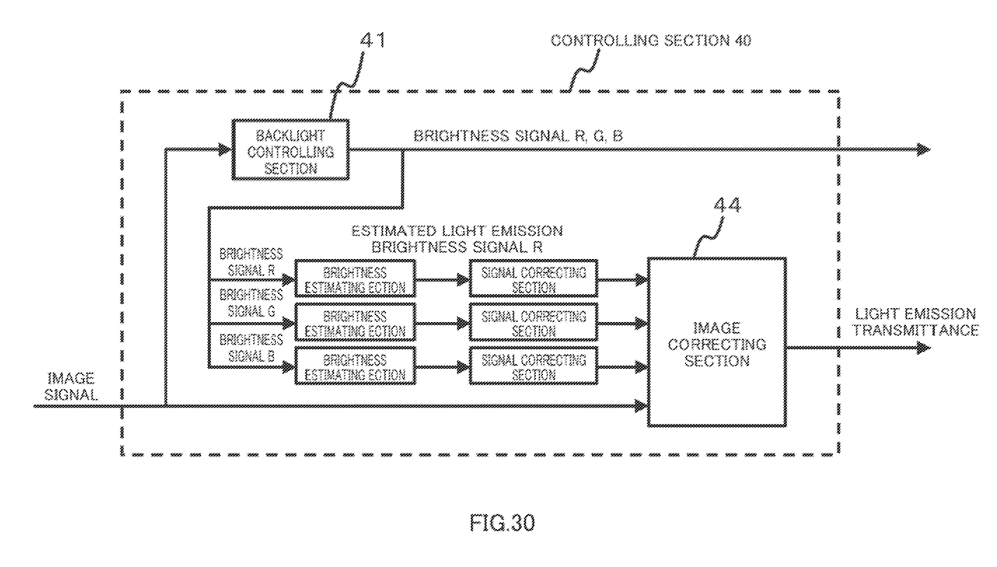

Further, as described in Embodiment 1, although light source 21 may emit white light by blending red, green and blue lights, the same applies to Embodiments 2 and 3. In this case, a configuration is also possible where light emission brightnesses of red, green and blue can be individually controlled. FIG. 30 shows a configuration of a controlling section of a liquid crystal display apparatus with a backlight that can control red, green and blue independently. Backlight controlling section 41 outputs brightness signals corresponding to red, green and blue. In the brightness estimating section and the signal correcting section, three systems supporting red, green and blue are provided. With this configuration, it is possible to calculate estimated light emission brightness values for red, green and blue.

With the above configuration, it is possible to calculate an estimated light emission brightness value in a pixel of interest more accurately even in case where light emission brightnesses of red, green and blue can be controlled independently.

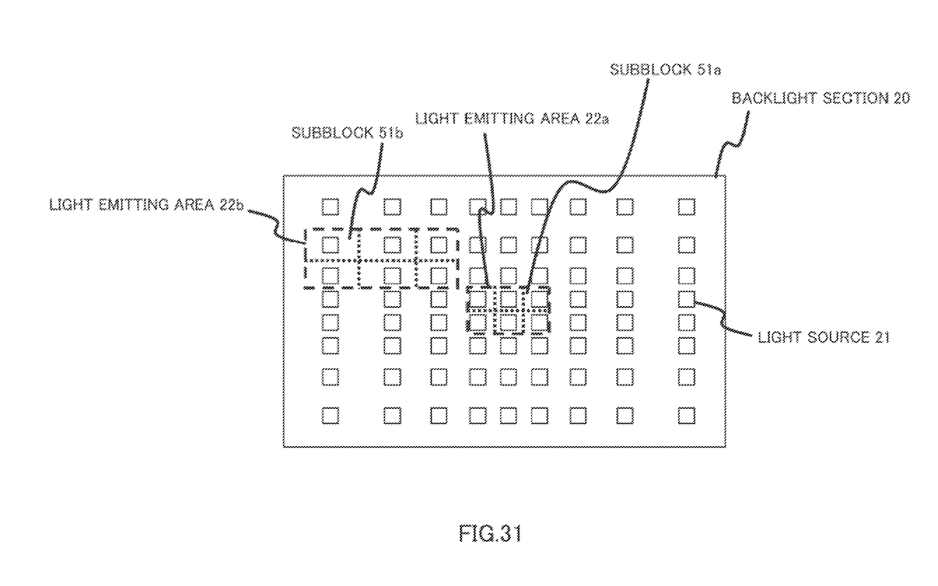

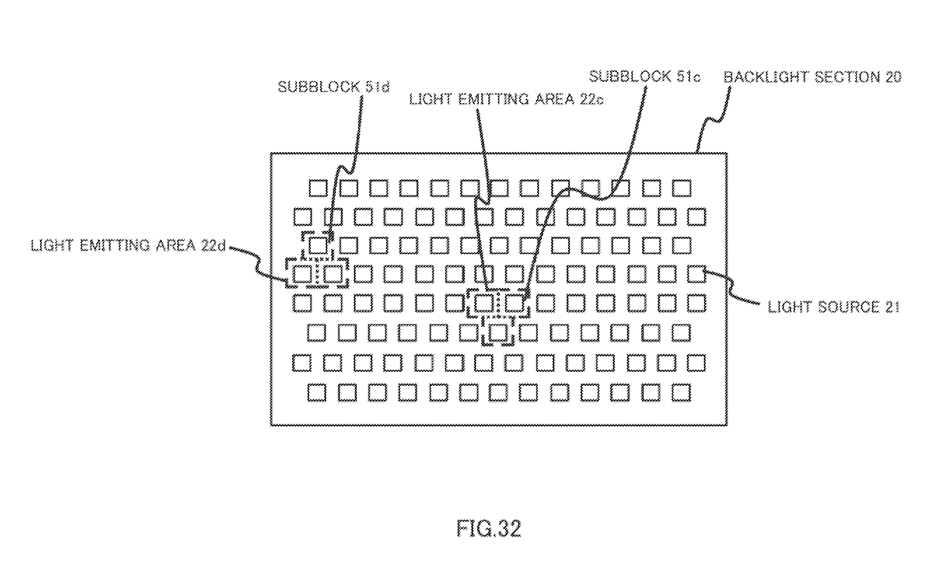

Further, although Embodiments 1 to 3 have been explained assuming that light sources 21 are aligned at regular pitches, the present invention is also applicable even in case of a configuration where light sources 21 are aligned at irregular pitches. FIG. 31 shows an example of irregular pitch alignment. With this example, in light emitting area 22a near the center of backlight section 20, light sources 21 are arranged more densely than in light emitting area 22b near the outer periphery. In this case, light emission characteristics inside individual light emitting areas vary. Even if the irregular pitch alignment is adopted in this way, light emitting areas 22a and 22b only need to be segmented such that the number of light sources disposed in subblocks 51a and 51b acquired from light emitting areas 22a and 22b is equal. That is, it is indicated that, although the areas of subblocks are different, the number of light sources inside a subblock is the same. As shown in, for example, FIG. 32, the same applies to the case where a plurality of light sources 21 forming a plurality of light emitting areas (e.g. light emitting areas 22c and 22d) in backlight section 20 are aligned in a delta pattern. In case where light emitting areas 22c and 22d of the delta alignment are segmented, it is preferable to segment light emitting areas 22c and 22d such that both subblocks 51c and 51c acquired from light emitting areas 22c and 22d each include one light source.

Note that, although Embodiments 1 to 3 have been explained assuming that backlight section 20 is a direct type backlight apparatus, the present invention is applicable in case of a backlight apparatus other than the direct type backlight apparatus as long as it can change the brightness of the backlight locally.

Further, it is equally possible to mutually combine above Embodiments 1 to 3 for use. Furthermore, it is also possible to combine another embodiment with Embodiments 1 to 3 for use.

### INDUSTRIAL APPLICABILITY

The image display apparatus according to the present invention can display high-quality images, and therefore is useful as an image display apparatus such as a PC monitor or digital TV.

### REFERENCE SIGNS LIST

10 LIQUID CRYSTAL PANEL
20 BACKLIGHT SECTION
21 LIGHT SOURCE
22, 22a-22d LIGHT EMITTING AREA
23 VIRTUAL LIGHT SOURCE
30 BACKLIGHT DRIVER
40 CONTROLLING SECTION
41 BACKLIGHT CONTROLLING SECTION
42 BRIGHTNESS ESTIMATING SECTION
43 SIGNAL CORRECTING SECTION
44 IMAGE CORRECTING SECTION
51, 51a-51d SUBBLOCK
61 PIXEL
421 BLOCK MEMORY CONTROLLING SECTION
422 BLOCK MEMORY
423 SUBBLOCK SEGMENTING SECTION
424 SUBBLOCK MEMORY CONTROLLING SECTION
425 SUBBLOCK MEMORY
426, 1401 BRIGHTNESS DISTRIBUTION FILTER SECTION
427 INTERPOLATING SECTION
1101 SUBBLOCK OF INTEREST
1102 FILTER IN BRIGHTNESS DISTRIBUTION FILTER SECTION
1402 HORIZONTAL DIRECTION BRIGHTNESS DISTRIBUTION FILTER SECTION
1403 VERTICAL DIRECTION BRIGHTNESS DISTRIBUTION FILTER SECTION
1505 ONE-DIMENSIONAL FILTER HAVING HORIZONTAL BRIGHTNESS DISTRIBUTION CHARACTERISTICS
1801 ONE-DIMENSIONAL FILTER HAVING VERTICAL BRIGHTNESS DISTRIBUTION CHARACTERISTICS
2101 BRIGHTNESS ESTIMATING SECTION
2102 FIRST BRIGHTNESS DISTRIBUTION FILTER SECTION
2103 SECOND BRIGHTNESS DISTRIBUTION FILTER SECTION
2201 FILTER IN FIRST BRIGHTNESS DISTRIBUTION FILTER SECTION
2601 FILTER IN SECOND BRIGHTNESS DISTRIBUTION FILTER SECTION
2701 FILTER PROCESSING RANGE
2901 REFLECTING PLATE
2902, 2903, 2904 VIRTUAL BACKLIGHT SECTION

1. An image display apparatus comprising:
a light source section that comprises a plurality of light sources disposed such that a plurality of light emitting areas are formed;
a display section that displays an image by modulating light from the light source section according to a modulation factor corresponding to an input image signal;
a light controlling section that generates a first brightness signal which indicates a brightness value, per light emitting area, and that controls a light emission brightness value of the light source section per light emitting area using the generated first brightness signal; and
a controlling section that controls the image display apparatus,
wherein the controlling section:
calculates the modulation factor based on the input image signal and a brightness value of light which is determined from the generated first brightness signal, the light arriving at pixels of the display section;
generates a second brightness signal which indicates a brightness value, per sub-area acquired by segmenting a light emitting area, based on the generated first brightness signal; and
performs processing corresponding to a brightness distribution of a light emitting area, with respect to the generated second brightness signal.

2. The image display apparatus according to claim 1, wherein a size of the sub-area is larger than a pixel.

3. The image display apparatus according to claim 1, wherein a shape of the sub-area is more similar to a rectangular shape than a light emitting area.

4. The image display apparatus according to claim 1, wherein the number of sub-areas acquired from one light emitting area is equal to a number of light sources provided in the one light emitting area.

5. The image display apparatus according to claim 1, wherein the controlling section generates second brightness signals such that brightness values of the second brightness values generated for all sub-areas acquired from a same light emitting area are the same.

6. The image display apparatus according to claim 1, wherein the controlling section generates second brightness signals for a plurality of sub-areas acquired from a same light emitting area, according to at least one of a degree of diffusion of light from each light source, a method of disposing each light source and a number of light sources in the same light emitting area.

7. The image display apparatus according to claim 1, wherein:
a plurality of sub-areas acquired from all light emitting areas are arranged two-dimensionally; and
the controlling section applies a two-dimensional filter having characteristics corresponding to a brightness distribution of a light emitting areas, to the generated second brightness signals.

8. The image display apparatus according to claim 1, wherein:
a plurality of sub-areas acquired from all light emitting areas are arranged two-dimensionally;
the controlling section applies a first and a second filter individually to the generated second brightness signals;
the first filter is a one-dimensional filter having characteristics corresponding to a horizontal brightness distribution of a light emitting area; and
the second filter is a one-dimensional filter having characteristics corresponding to a vertical brightness distribution of a light emitting area.

9. The image display apparatus according to claim 1, wherein:
the controlling section applies a first filter to generated first brightness signals, generates second brightness signals based on the first brightness signals after the first filter is applied and applies a second filter to the generated second brightness signals;
the first filter has characteristics corresponding to a large scale brightness distribution of a light emitting area; and
the second filter has characteristics corresponding to a local brightness distribution of a light emitting area.

10. A controlling apparatus that controls an image display apparatus that displays an image, by modulating light from a light source section comprising a plurality of light sources disposed such that a plurality of light emitting areas are formed, according to a modulation factor corresponding to an input image signal, the controlling apparatus comprising:
a light source controlling section that generates a first brightness signal which indicates a first brightness signal, per light emitting area, and that controls a light emitting brightness value of the light source section per light emitting area using the generated first brightness signal; and
a controlling section that calculates a modulation factor based on the input image signal and a brightness value of light that is determined from the generated first brightness signal, the light arriving at a pixel of the display section,
wherein the controlling section generates a second brightness signal which indicates a brightness value, per sub-area acquired by segmenting a light emitting area, based on the generated first brightness signal, and performs processing corresponding to a brightness distribution in a light emitting area, with respect to the generated second brightness signal.

11. An integrated circuit that controls an image display apparatus, wherein:
the image display apparatus comprises:
a light source section that comprises a plurality of light sources disposed such that a plurality of light emitting areas are formed;
a display section that displays an image by modulating light from the light source section according to a modulation factor corresponding to an input image signal;
the integrated circuit comprises:
a light source controlling section that generates a first brightness signal which indicates a brightness value, per light emitting area, and that controls a light emission brightness value of the light source section per light emitting area, using the generated first brightness signal;
a controlling section that controls the image display apparatus; and
the controlling section:
calculates the modulation factor based on the input image signal and a brightness value of light that is determined from the generated first brightness signal, the light arriving at a pixel of the display section;
generates a second brightness signal which indicates a brightness value, per sub-area acquired by segmenting a light emitting area, based on the generated first brightness signal; and
performs processing corresponding to a brightness distribution of a light emitting area, with respect to the generated second brightness signal.
